(19) United States
(12) Patent Application Publication
(10) Pub. No.: US 2021/0342738 A1
(43) Pub. Date: Nov. 4, 2021

(54) MACHINE LEARNING-FACILITATED DATA ENTRY

(71) Applicant: SAP SE, Walldorf (DE)

(72) Inventor: Siar Sarferaz, Heidelberg (DE)

(73) Assignee: SAP SE, Walldorf (DE)

(21) Appl. No.: 16/865,021

(22) Filed: May 1, 2020

(51) Int. Cl. G06N 20/00; G06F 3/0484

(52) U.S. Cl. CPC G06N 20/00; G06F 3/0484

(57) ABSTRACT

Techniques and solutions are described for facilitating data entry using machine learning techniques. A machine learning model can be trained using values for one or more data members of at least on type of data object, such as a logical data object. One or more input recommendation functions can be defined for the data object, where an input recommendation method is configured to use the machine learning model to obtain one or more recommended values for a data member of the data object. A user interface control of a graphical user interface can be programmed to access a recommendation function to provide a recommended value for the user interface control, where the value can be optionally set for a data member of an instance of the data object. Explanatory information can be provided that describes criteria used in determining the recommended value.

### FIELD

The present disclosure generally relates to machine learning techniques. Particular implementations relate to the use of machine learning techniques to facilitate data entry, including data entry input that may trigger one or more processes.

### BACKGROUND

Software applications, particularly enterprise-level applications, including enterprise resource planning (ERP) software, can involve complex data models. Input provided by users can affect analog-world activities. Input in some cases can trigger processes that can be carried out at least in part using software applications. For example, in a manufacturing process, issues can arise in the production of a finished good. If an issue is encountered, the user may be required to enter a code describing the issue, such as a defect code. In turn, the defect code may trigger processes to log or remedy the defect. Certain kinds of defects, for example, may indicate that machinery should be repaired or serviced.

A given software application can have many, perhaps hundreds, of different input fields. Each input field can be associated with unconstrained entry (e.g., a user can enter any desired text, such as a textual description of an issue that was encountered) or may have acceptable input constrained to particular values (including values that may be foreign keys to a particular database table, such as a database table containing master data). Although some input fields may be constrained, the number of options for any given field can still be very large. In addition, input fields may be interdependent, where a choice made for one input field limits valid values for another input field. Contributing to the complexity of data entry, acceptable input values are often in the form of numbers, abbreviations, acronyms, or codes. Input values with no, or limited, semantic meaning may make it more difficult for users to complete a data entry process, or to complete it accurately. Inaccurate data entry can have negative consequences, such as failing to trigger a proper remedial action or taking an action that worsens an issue or creates further issues. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are described for facilitating data entry using machine learning techniques. A machine learning model can be trained using values for one or more data members of at least one type of data object, such as a logical data object. One or more input recommendation functions can be defined for the data object, where an input recommendation method is configured to use the machine learning model to obtain one or more recommended values for a data member of the data object. A user interface control of a graphical user interface can be programmed to access a recommendation function to provide a recommended value for the user interface control, where the value can be optionally set for a data member of an instance of the data object. Explanatory information can be provided that describes criteria used in determining the recommended value.

In one aspect, a method is provided for obtaining a recommended value for a user interface control of a graphical user interface. A request is received for a putative value for a first user interface control of the graphical user interface. The putative value can be a recommended value and the request can be an input recommendation request. A method is determined that is specified for the user interface control. The method can be a member function of a logical data object that includes a plurality of variables, such as data members, and can be an input recommendation method. The user interface control is programmed to specify a first value for at least a first variable of the plurality of variables.

A second value is retrieved for at least a second variable of the plurality of variables. The second value is provided to a trained machine learning model specified for the method. At least one result value is generated for the first value using the trained machine learning model. The at least one result value is displayed on the graphical user interface as the putative value.

In another aspect, a method is provided for defining an input recommendation method for a logical data object. A machine learning model is trained with values for a plurality of data members of at least a first type of logical data object to provide a trained machine learning model. A first interface to the trained machine learning model is defined for a first value generation method (i.e., an input or value recommendation method) of the first type of logical data object. The first value generation method for the first type of logical data object is defined. The first value generation method specifies the first interface.

In a further aspect, a method is provided for registering an input recommendation method with a user interface control of a display of a graphical user interface. A first interface is defined for a trained machine learning model for a first value generation method (e.g., an input or value recommendation method) of a first type of data object (such as a logical data object). The machine learning model has been trained by processing data for a plurality of instances of the first type of data object with a machine learning algorithm. The first value generation method for the first type of data object is defined. The first value generation method specifies the first interface. The first value generation method is registered with a first user interface control of a first display of a graphical user interface.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a block diagram depicting a schema for a logical data object.

FIG. 2 is a diagram illustrating how a value provided for one user interface control can limit valid values for other user interface controls.

FIG. 3 is a diagram of a computing architecture having a local system and a cloud system, where each system can provide machine learning functionality.

FIG. 4 is a diagram illustrating a computing architecture in which disclosed technologies can be implemented.

FIGS. 5A and 5B are timing diagrams illustrating operations in obtaining an input recommendation for a user interface control.

FIG. 6 is a diagram of an example user interface screen having a user interface control that is associated with an input assistant that can provide a recommended value for the user interface control.

FIG. 7 is a diagram of a computing architecture that can be used to provide an input recommendation for the user interface control of the user interface screen of FIG. 6.

FIG. 8A provides example code that can be used to train a machine learning model useable in the computing architecture of FIG. 7.

FIG. 8B provides example code that can be used to implement a model interface that can be used to obtain an input recommendation from a machine learning model trained according to the code of FIG. 8A.

FIG. 9 is a diagram illustrating options for providing recommended input values to a user, such as using the user interface control of FIG. 6.

FIG. 10 is a flowchart of a method for obtaining an input recommendation for a user interface control.

FIG. 11 is a flowchart of a method for defining an input recommendation method for a logical data object.

FIG. 12 is a flowchart of a method for registering an input recommendation method with a user interface control.

FIG. 13 is a diagram of an example machine learning scenario having model segments.

FIG. 14 is a diagram of an example machine learning scenario having customized hyperparameters.

FIG. 15 is a timing diagram illustrating a process for training a machine learning model with multiple model segments, and use thereof.

FIG. 16 is an example virtual data model definition of a view that includes a specification of machine learning model segments.

FIGS. 17-22 are example user interface screens allowing a user to configure a machine learning model, including model segments and custom hyperparameters.

FIG. 23 is an example processing pipeline for a machine learning scenario.

FIG. 24 is an example table of metadata that can be used in an example machine learning scenario that can use disclosed technologies.

FIG. 25 is a schematic diagram illustrating how values used as input for a machine learning model, either to train the model or for classification, can be associated with features.

FIG. 26 is a schematic diagram illustrating how values used as input for a machine learning model, either to train the model or for classification, can be associated with features, and how different features can contribute to a result in differing degrees.

FIG. 27 is matrix illustrating dependency information between features used as input for a machine learning model.

FIG. 28 is plot illustrating relationships between features used as input for a machine learning model.

FIG. 29 is a diagram schematically illustrating how user interface screens can display increasingly granular levels of machine learning explanation information.

FIGS. 30A-30D are example user interface screens presenting machine learning explanation information at various levels of granular detail.

FIG. 31 is timing diagram illustrating a process for generating machine learning explanation information.

FIGS. 32 and 33 are diagrams illustrating example computing architectures in which disclosed technologies can be implemented.

FIG. 34 is a schematic diagram illustrating relationships between table elements that can be included in a data dictionary, or otherwise used to define database tables.

FIG. 35 is a schematic diagram illustrating components of a data dictionary and components of a database layer.

FIG. 36 is a diagram of an example computing system in which some described embodiments can be implemented.

FIG. 37 is an example cloud computing environment that can be used in conjunction with the technologies described herein.

### DETAILED DESCRIPTION

### Example 1—Overview

Software applications, particularly enterprise-level applications, including enterprise resource planning (ERP) software, can involve complex data models. Input provided by users can affect analog-world activities. Input in some cases can trigger processes that can be carried out at least in part using software applications. For example, in a manufacturing process, issues can arise in the production of a finished good. If an issue is encountered, the user may be required to enter a code describing the issue, such as a defect code. In turn, the defect code may trigger processes to log or remedy the defect. Certain kinds of defects, for example, may indicate that machinery should be repaired or serviced.

A given software application can have many, perhaps hundreds, of different input fields. Each input field can be associated with unconstrained entry (e.g., a user can enter any desired text, such as a textual description of an issue that was encountered) or may have acceptable input constrained to particular values (including values that may be foreign keys to a particular database table, such as a database table containing master data). Although some input fields may be constrained, the number of options for any given field can still be very large. In addition, input fields may be interdependent, where a choice made for one input field limits valid values for another input field. Contributing to the complexity of data entry, acceptable input values are often in the form of numbers, abbreviations, acronyms, or codes. Input values with no, or limited, semantic meaning may make it more difficult for users to complete a data entry process, or to complete it accurately. Inaccurate data entry can have negative consequences, such as failing to trigger a proper remedial action or taking an action that worsens an issue or creates further issues. Accordingly, room for improvement exists.

The present disclosure uses machine learning techniques to fully or partially automate a data entry process. One (or more) machine learning techniques can be used to analyze data, such as historical data, for an input field. In some cases, the data for the input field can be analyzed in the context of other, related input fields, or other related data. The related input fields or other related data can be associated with an abstract or composite data type, such as for an object in an object-oriented programming paradigm (e.g., a class). In particular, the abstract data type can be a logical data object, such as BusinessObjects as used in software available from SAP SE, of Walldorf, Germany. The related data can be part of the same abstract data type as a given input field, or can be part of a related abstract data type.

Historical data can be analyzed to suggest one or more values for an input field. The suggested values can be automatically used in some cases, while in other cases a user confirms whether a suggested value should be used as an input value. In particular implementations, the user can be provided with information that can help them understand why particular values were selected, or how the multiple proposed values compare to one another (e.g., a qualitative assessment of how likely it is that a given value is “correct” for the given input field).

The defect management process described above provides an example where an input assistant using disclosed technologies can improve a data entry process. In the context of this process, a quality technician may record a product defect in a computing system by providing a description of the defect and assigning the defect to a defect code group (such as numerical value representing a particular type or class of defect). However, determining the correct defect code group can be difficult and can result in wrong assignments. For example, the defect code may be a numerical value that does not convey the semantic meaning of the underlying error. Correct assignment of the defect code group can be important, as different, dedicated defect code group follow-up processes may be triggered for different defect code group values.

An input assistant using disclosed technologies can help by recommending an appropriated defect code group based on the defect description entered by the quality technician. For example, the input assistant can use a machine learning model trained using historical defect code descriptions and code group assignments.

As explained above, disclosed innovations can be used with sets of related data, such as data associated with data members defined for an abstract or composite data type, including a logical data object. Example 2 describes a particular kind of logical data object that can be used with disclosed technologies. Example 3 describes how a set of related data members can have different values, and where a value selected for one data member can constrain choices for other data members. Examples 4-9 describe how disclosed innovations can be used to suggest values for data members using machine learning techniques. Examples 10-17 describe how machine learning model segments may be generated for various data subsets used with a machine learning model, where segments can be generated, for example, using different values for one or more data members. The machine learning model segments can be used in the techniques described in this Example 1 and Examples 4-9, and can, at least in some cases, provide more accurate suggestions for an input field. Examples 18-25 describe how information describing how a machine learning result determined using the techniques of Examples 4-9 can be generated and provided to a user, which can help satisfy regulatory requirements for the use of machine learning techniques, and, more generally, can help a user determine whether a value suggested using machine learning should be accepted for an input field. Examples 26 and 27 describe elements of a schema for a database or a virtual data model, where a virtual data model can be mapped (e.g., using object relational mapping) to data maintained in a database.

### Example 2—Example Logical Data Object Schema

In any of the Examples described herein, a logical data object be a specific example of an object in an object-oriented programming approach. However, unless the context specifically indicates otherwise, aspects of the present disclosure described with respect to logical data objects can be applied to other types of objects, or other types of data collections. For example, a database table, or a group of related tables, can have fields that are analogous to data members of an object. Functions that correspond to member functions of an object can be defined to perform operations on the tables.

A logical data object can contain a definition of a hierarchical data structure and definitions of one or more operations that can be performed using portions of the hierarchical data structure. In some cases, a logical data object may be referred to as a “business object” and can take any number of forms including business intelligence or performance management components such as those implemented in software technologies of SAP BusinessObjects, ORACLE Hyperion, IBM Cognos, and others. However, the use of logical data objects in computer applications is not limited to “business” scenarios. Logical data objects can be used to define a particular application and/or problem domain space. Aspects and artifacts of a given problem domain can be defined using the hierarchical data structure and various portions of these aspects and/or artifacts can be associated directly with definitions of relevant logical operations. A logical data object can be an artefact of a virtual data model, or can be constructed with reference to artefacts of a virtual data model. In turn, components of the virtual data model can be mapped to another data model, such as a physical data model of a relational database system.

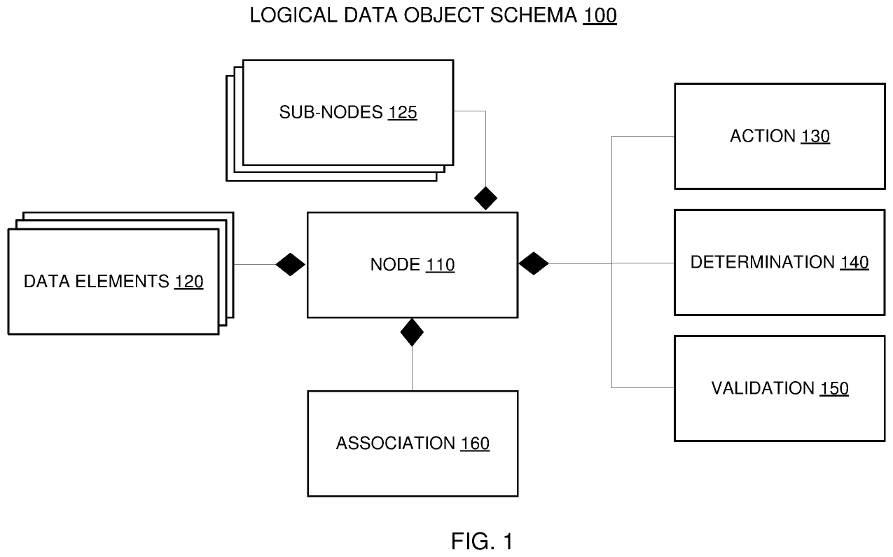

FIG. 1 is a diagram of an example logical data object schema 100. A node 110 can contain one or more data elements 120 (i.e., variables, such as data members). A data element 120 can contain an identifier, such as a name, and an associated value. The identifier can, for example, be associated with a field of a particular database table. In at least some embodiments, the data element 120 can be associated with a data type that restricts and/or validates the type of data that can be stored as a value of the data element 120.

The node 110 can contain one or more child nodes 125 (also referred to as sub-nodes), which can themselves contain additional data elements 120 (and other node components, including sub-nodes 125). Combinations of sub-nodes 125 can be used to define a hierarchical data structure of multiple nodes 110. In at least some embodiments, the hierarchical data structure can contain a root node that does not have a parent-node and can be used as an entry point for traversing the hierarchical data structure.

Each node 110 in the logical data object can be associated with one or more actions 130. An action 130 can comprise a definition for a logical operation that can be performed using the node 110 with which it is associated. The action 130 can contain an identifier that can be used to invoke the action's logical operation. Each node 110 in the logical data object can be associated with one or more determinations 140. A determination 140 can contain a definition for a logical operation that can be automatically executed when a trigger condition is fulfilled. Example trigger conditions can include a modification of the associated node 110, a modification of the data element 120 of the associated node, the creation of a data element 120 of the associated node, etc. A logical operation defined by an action 130, or a determination 140, can comprise instructions to create, update, read, and/or delete one or more data elements 120 and/or one or more sub-nodes 125. Actions 130 or determinations 140 can be set to trigger, in some cases, upon the occurrence of a particular date (e.g., a particular date or a particular time on a particular date).

Each node 110 in the logical data object schema 100 can be associated with one or more validations 150. A validation 150 can contain a definition of one or more data integrity rules and/or checks. The one or more data integrity rules and/or checks can be performed when the associated node 110, and/or one or more data elements 120 of the associated node, are created, modified, and/or deleted. Any such operation that does not satisfy the one or more data integrity rules and/or checks can be rejected.

Each node 110 in the logical data object schema 100 can be associated with one or more nodes from one or more other logical data objects (having the same schema or a different schema) by one or more associations 160. An association 160 can contain an identifier for a node in another logical data object that is associated with the node 110. Associations 160 can be used to define relationships among nodes in various logical data objects. The association 160, in at least some embodiments, contains an association type indicator that identifies a type of association between the node 110 and the node in the other logical data object.

Although the action 130 as defined and associated with the node 110, when the action 130 is invoked, it targets an identified instance of the node 110 with which it is associated. Similarly, a determination 140 and/or validation 150 can be defined and associated with a node 110, but can target an instance of the associated node 110 when it/they is/are invoked. Multiple instances of a given logical data object can be created and accessed independently of one another. Actions 130, determinations 140, or validations 150 may correspond to member functions of a data object, such as implemented in a C++ class.

Although the instances of the logical data object share a common schema 100, the data values stored in their respective node instances and data element instances can differ, as can the logical data object instances that are associated by the associations 160. Additionally, or alternatively, an instance of an association 160 can identify a particular instance of an associated node in another logical data object instance. The identifier of a node instance can be an alphanumeric string that uniquely identifies the instance and, in at least some cases, can be used to look the instance up and/or retrieve data associated with the instance. Particular examples of identifiers include numerical values and universally unique identifiers. However, other types of identifiers are also possible.

Various actions may be performed using logical data objects including create, update, delete, read, and query operations. If the requested operation is a read operation, the data payload may contain a unique identifier associated with a logical data object instance to be retrieved. Processing a read operation request can comprise searching for an instance of the logical data object that is associated with the provided unique identifier in a data store, and retrieving all or part of a matching logical data object instance's data from the data store. If the requested operation is an update operation, the data payload may contain one or more values to be assigned to data element instances of an existing logical data object instance. The data payload may also contain a unique identifier associated with the logical data object instance to be updated. Processing an update operation request can comprise searching for a logical data object instance in a data store associated with the provided unique identifier and updating the matching logical data object instance with the provided data values.

### Example 3—Example User Interface with Multiple User Interface Controls for Entering Values for Interdependent Variables

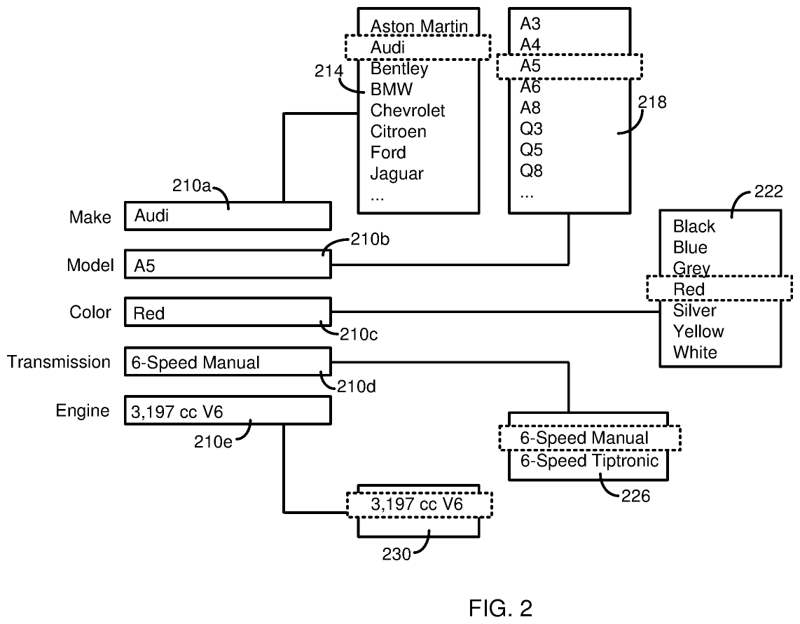

FIG. 2 illustrates how input fields may each be associated with particular values, which can be values that are valid for the given input field, and how a selection made for one input field can constrain valid values for other input fields. Or, even if one input field does not constrain an input field, a value for a first input field may make values for other input fields more or less likely to be the intended or “correct” value.

The input fields can represent user interface controls for a graphical user interface. The graphical user interface can be a particular user interface screen of an application, such as screen that provides a form or otherwise allows a user to enter data. Data entered via the input fields can, in some cases, trigger a process that is at least partially computer-implemented. For example, based on values provided for a field, alerts may be provided to users, documents or requests generated, or physical machinery may be activated or deactivated.

FIG. 2 provides a plurality of input fields 210, shown as input fields 210a-210e, which relate to specifying properties for a vehicle. Input provided via the fields 210 may result in the initiation of a manufacturing process to assemble a vehicle having the properties specified by the input, or placing an order for such a vehicle, where the vehicle may have already been manufactured. Input field 210a represents a make (or manufacturer) of the vehicle, input field 210b represents a vehicle model, input field 210c specifies the color of the vehicle, input field 210d specifies a transmission type for the vehicle, and input field 210e specifies an engine type for the vehicle. Intuitively, it can be understood how selecting a value for one input field can constrain valid values for other input fields. For example, selecting “Audi” for a vehicle manufacturer in field 210a limits models for field 210b to models available from “Audi”—it would not make sense to select a F-150, made by “Ford” as the vehicle model. Similarly, once a make and model have been selected, that may limit the valid values for color (e.g., some vehicles may only come in specified colors), transmission types (e.g., some vehicles may only be available with automatic transmissions), and engine options.

FIG. 2 illustrates options 214 for input field 210a. It can be seen that “Audi” has been selected. Based on the selection of “Audi” for input field 210a, options 218 can be available for the “model” input field 210b. Note that the options 218 may be only a subset of all possible values for “model,” when “model” is not subject to other constraints. In some cases, an input field can be constrained so that only valid values are available to a user. In other cases, a user may enter any value, or at least any value that is specified as a possible value for “model,” even if the combination does not “make sense”/exist (e.g., a F-150 manufactured by Audi).

Even if options 218 are not restricted to valid values based on the value selected for input field 210a, analyzing other data, such as historical records for vehicle production orders/purchase orders may reveal a practical correlation between “Audi” and the options 218. These approaches can be used together, such as constraining options 218 to models made by “Audi,” but using historical data to suggest a model most likely to be selected by a user for input field 210b given Audi as the manufacturer. Note that a benefit of using historical data to train a machine learning algorithm to suggest values for input fields is that it can practically take constraints between input fields (and other data) into account, but without needing to explicitly define such constraints. If circumstances change, or new data patterns otherwise develop, machine learning techniques can be self-correcting. That is, if a user rejects suggested values, that feedback can be used to improve future results (e.g., in the form of additional training data for the machine learning algorithm or correction of the machine learning model, such as using backpropagation).

Selecting an option of the “make” options 214 and the “model” options can similarly limit options 222 for the input field 210c, options 226 for the input field 210d, and options 230 for the input field 210e.

### Example 4—Example Architecture Providing for Machine Learning at Local and Cloud Systems

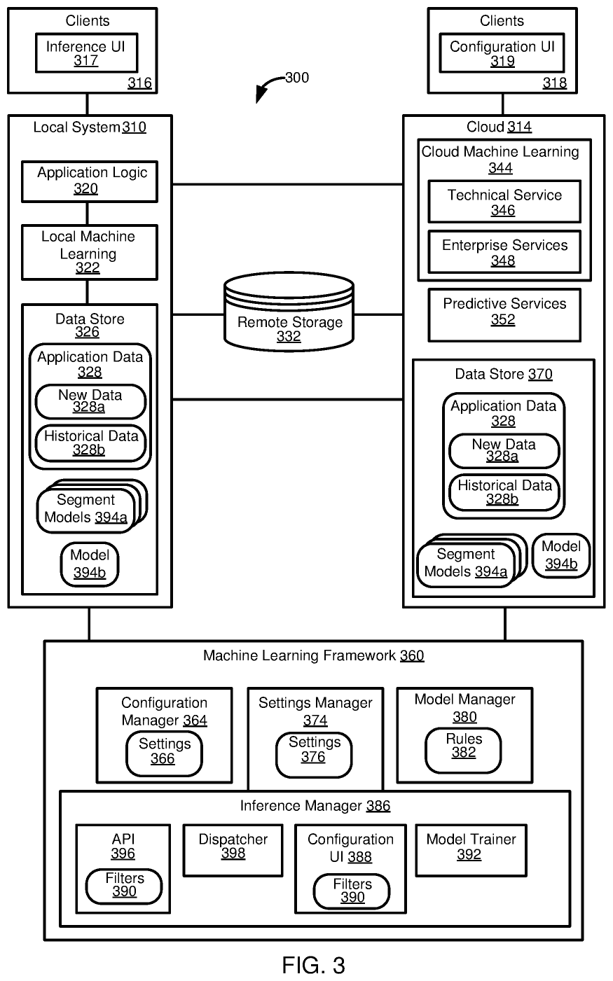

FIG. 3 illustrates a computing architecture 300 in which disclosed technologies can be used. Generally, the architecture 300 includes a local system 310 and a cloud-based system 314, which can have respective clients 316, 318. The local system 310 can include application logic 320, which can be logic associated with one or more software applications. The application logic 320 can use the services of a local machine learning component 322.

The local machine learning component 322 can include one or more machine learning algorithms, and optionally one or more specific tasks or processes. For instance, the local machine learning component 322 can have functionality for conducting an association rule mining analysis, where the application logic 320 (including as directed by an end user) can call the associated function of the local machine learning component. In carrying out the requested function, the local machine learning component 322 can retrieve application data 328 from a data store 326, such as a relational database management system. Alternatively, all or a portion of data to be used by the local machine learning component 322 can be provided to the local machine learning component by the application logic 320, including after being retrieved by, or on behalf of, the application logic from the data store 326.

The application data 328 can include new application data 328a and historical application data 328b. New application data 328a can include data that is currently in the process of being input or which is in an uncompleted or unverified state. Historical application data 328b can include application data for a completed document or process (or a data object instances of a data object that represents a document, process, etc.), and can include data that was input without the assistance of an input assistant according to the present disclosure. Application data input using the input assistant, such as data confirmed or corrected by a user, can also be included in the historical application data 328b. As will be further described, historical application data 328b can be used to train a machine learning algorithm to provide a machine learning model that can be used to predict a value for an input field.

The application logic 320 can store, or cause to be stored, data in a remote storage repository 332. The remote storage repository 332 can be, for instance, a cloud-based storage system. In addition, or alternatively, the application logic 320 may access data stored in the remote storage repository 332. Similarly, although not shown, in at least some cases, the local machine learning component 322 may access data stored in the remote storage repository 332. The remote storage 332 can store, in some cases, application data 328, such as historical application data 328b.

The local system 310 may access the cloud-based system 314 (in which case the local system may act as a client 318 of the cloud-based system). For example, one or more components of the cloud-based system 314 may be accessed by one or both of the application logic 320 or the local machine learning component 322. The cloud-based system 314 can include a cloud machine learning component 344. The cloud machine learning component 344 can provide various services, such as technical services 346 or enterprise services 348. Technical services 346 can be data analysis that is not tied to a particular enterprise use case. Technical services 346 can include functionality for document feature extraction, image classification, image feature extraction, time series forecasts, or topic detection. Enterprise services 348 can include machine learning functionality that is tailored for a specific enterprise use case, such as classifying service tickets and making recommendations regarding service tickets.

The cloud system 314 can include predictive services 352. Although not shown as such, in at least some cases the predictive services 352 can be part of the cloud machine learning component 344. Predictive services 352 can include functionality for clustering, forecasting, making recommendations, detecting outliers, or conducting “what if” analyses.

Although shown as including a local system 310 and a cloud-based system 314, not all disclosed technologies require both a local system 310 and a cloud-based system 314, or innovations for the local system need not be used with a cloud system, or vice versa.

The architecture 300 includes a machine learning framework 360 that can include components useable to implement one or more various disclosed technologies. Although shown as separate from the local system 310 and the cloud system 314, one or both of the local system or the cloud system 314 can incorporate a machine learning framework 360. Although the machine learning framework 360 is shown as including multiple components, useable to implement multiple disclosed technologies, a given machine learning framework need not include all of the components shown. Similarly, when both the local system 310 and the cloud system 314 include machine learning frameworks 360, the machine learning frameworks can include different combinations of one or more of the components shown in FIG. 3.

The machine learning framework 360 can include a configuration manager 364. The configuration manager 364 can maintain one or more settings 366. In some cases, the settings 366 can be used to configure an application, such as an application associated with the application logic 320 or with an application associated with the local machine learning component 322, the cloud machine learning component 344, or the predictive services 352. The settings 366 can also be used in determining how data is stored in the data store 326 or a data store 370 of the cloud system 314 (where the data store can also store application data 328).

The machine learning framework 360 can include a settings manager 374. The settings manager 374 can maintain settings 376 for use with one or both of the local machine learning component 322, the cloud machine learning component 344, or the predictive services 352. The settings 376 can represent hyperparameters for a machine learning technique, which can be used to tune the performance of a machine learning technique, including for a specific use case.

The machine learning framework 360 can include a model manager 380, which can maintain one or more rules 382. The model manager 380 can apply the rules 382 to determine when a machine learning model should be deprecated or updated (e.g., retrained). The rules 382 can include rules that make a model unavailable or retrain the model using a current training data set according to a schedule or other time-based criteria The rules 382 can include rules that make a model unavailable or retrain the model using a current data set based on the satisfaction (or failure to satisfy) non-time based criteria. For example, the model manager 380 can periodically examine the accuracy of results provided by a machine learning model. If the results do not satisfy a threshold level of accuracy, the model can be made unavailable for use or retrained. In another aspect, the model manager 380 can test a machine learning model, including after the model has been created or updated, to determine whether the model provides a threshold level of accuracy. If so, the model can be validated and made available for use. If not, an error message or warning can be provided, such as to a user attempting to use the model.

The machine learning framework 360 can include an inference manager 386. The interference manager 386 can allow a user to configure criteria for different machine learning model segments, which can represent segments of a data set (or input criteria, such as properties or attributes that might be associated with a data set used with machine learning model). A configuration user interface 388 (also shown as the configuration user interface 319 of the client system 318) can allow a user (e.g., a key user associated with a client 316 or a client 318) to define segmentation criteria, such as using filters 390. The filters 390 can be used to define model segment criteria, where suitable model segments can be configured and trained by a model trainer component 392.

Trained models (model segments) 394 (shown as models 394a, 394b) can be stored in one or both of the local system 310 or the cloud system 314. The trained models 394 can be models 394a for particular segments (e.g., defined by a filter 390), or can be models 394b that are not constrained by filter criteria. Typically, the models 394b use a training data set that is not restricted by criteria defined by the filters 390. The models 394b can include models that were not defined using (or defined for use with) the machine learning framework 360. The models 394b can be used when the machine learning framework 360 is not used in conjunction with a machine learning request, but can also be used in conjunction with the machine learning framework, such as if filter criteria are not specified or if filter criteria are specified but do not act to restrict the data (e.g., the filter is set to use “all data”).

The filters 390 can be read by an application program interface 396 that can allow users (e.g., end users associated with a client 316 or a client 318) to request machine learning results (or inferences), where the filter 390 can be used to select an appropriate machine learning model segment 394a for use in executing the request. As shown, the client 316 can include an inference user interface 317 for making inference requests.

A dispatcher 398 can parse requests received through the application program interface 396 and route the request to the appropriate model segment 394a for execution.

### Example 5—Example Computing Architecture for Providing Access to an Input Recommendation Function of a Logical Data Object

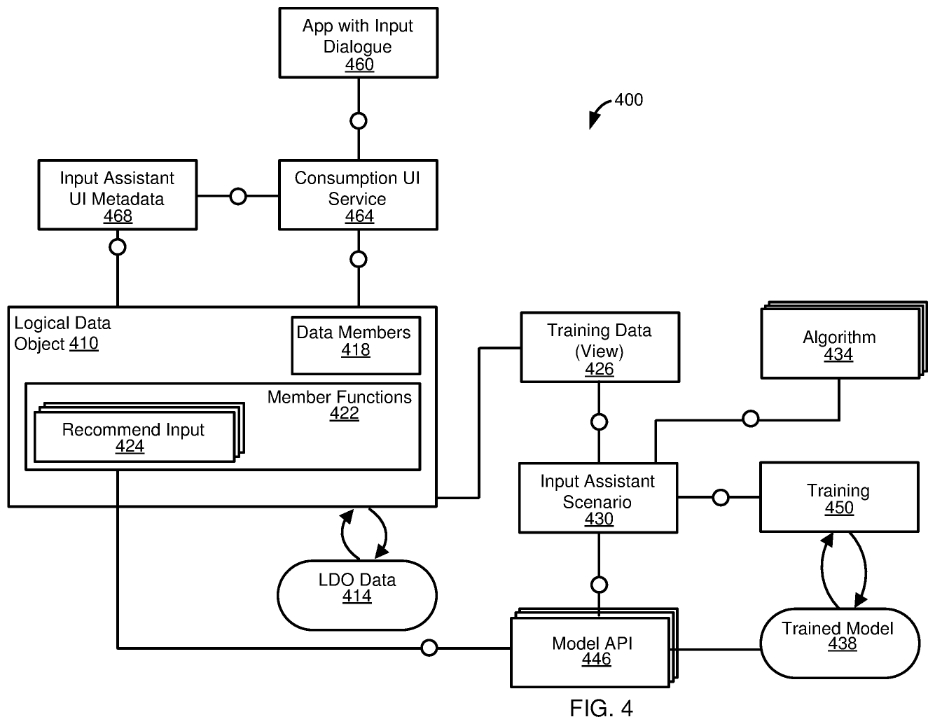

FIG. 4 illustrates an example architecture 400 in which disclosed technologies can be implemented. The architecture 400 includes a logical data object 410, such as a BusinessObject, as implemented in products available from SAP, SE, of Walldorf, Germany Although a single logical data object 410 is shown, the architecture 400 can include multiple logical data objects, where a given logical data object can otherwise be configured as shown.

At least some logical data objects in a computing system need not be associated with the architecture 400. That is, for example, some logical data objects may be associated with an input assistant, and therefore can be a logical data object 410. Other logical data objects need not be associated with an input assistant, and therefore are not configured as shown in FIG. 4. Even if a logical data object is not associated with an input assistant at a given point in time, it can have properties such that it can later be used with an input assistant. That is, for example, methods of the logical data object that allow it to be used with an input assistant can be activated or completed.

A logical data object 410 is associated with data. In particular, the logical data object 410 can include one or more data members 418 (e.g., similar to a C++ class). A given data member 418 for a given instance of a logical data object 410 can be mapped to one or more values in logical data object data 414. The logical data object data 414 can be stored, in some cases, in a database, such as a relational database. Values for the data members 418 of the logical data object 414 can be mapped to corresponding values in the logical data object data, such as using object relational mapping.

The logical data object 410 can also be associated with one or more member functions 422. At least one of the one or more member functions 422 is a recommend input method 424 useable to provide an input recommendation for an input field, where an input field can correspond to one of the data members 418 of the logical data object 410. For instance, if a logical data object includes a data member 418 for “Error Code,” an input recommendation member function 424 can be “getErrorCodeRecomendation,” which triggers a request to a machine learning model for one or more recommended values for the “ErrorCode” data member.

One or more training data views 426 can be defined that select an appropriate portion of the logical data object data 414 to be used with a machine learning algorithm, such as for model training. A training data view 426 can be defined at the level of a database that stores the logical data object data 414, or can be an artefact of a virtual data model that references the logical data object data, or references a view on the logical data object data that is an artefact of a database storing the logical data object data. In a particular example, the training data view 426 can be a CDS (core data services) view, as implemented in technologies available from SAP, SE, of Walldorf, Germany. In some cases, a training data view 426 can be defined for each recommend input member function 424. In other cases, a training data view 426 can select data that can be used for multiple, including all, recommend input member functions 424. Data selected by a training data view 426 can be filtered or processed prior to being used to train a machine learning model.

Training data views 426 can be registered with an input assistant scenario 430. An input assistant scenario 430 can store information about data artefacts that are used for a given purpose. An input assistance scenario 430 can store information such as an identifier for an application associated with one or more input recommendations, identifiers for user interface screens where input recommendations will be made available, logical data objects 410 or other data sources where data useable for training a data model or obtaining a recommendation can be retrieved, information (e.g., an identifier for a data member 418) indicating where an input recommendation should be stored, member functions 424 for obtaining input recommendations, machine learning algorithms 434 used in obtaining recommendations for different member functions, or identifiers for trained models 438 to be used in obtaining recommendations. A training function 450 can also be specified in the input assistant scenario 430.

The input assistant scenario 430 can be maintained as a data object, including as an abstract or composite data type, including as a type of logical data object. The input assistant scenario 430 can be maintained in other formats, such as in a table or an XML document.

The input assistant scenario 430 can specify model application program interfaces (APIs) 446 that can be used to obtain input recommendations for a given input field (e.g., a given data member 418 of a logical data object 410). The model APIs 446 can be exposed by the trained machine learning models 438, and can be called by recommended input member functions 424.

A training function 450 can be called, such as by the input assistant scenario 430, to produce the trained models 438. The training function 450 can be part of a machine learning application, platform, or framework. The input assistant scenario 430 can specify how training should be conducted, including specifying one or more algorithms 434 to be used and training data, such as all or a subset of data provided by the training data view 426.

The input assistant scenario 430 can define model segments for machine learning models, such as based on particular values or sets of values for one or more data members 418 of the logical data object 410, such as described in Examples 10-17. For example, taking the scenario of Example 2, model segments may be trained by vehicle manufacturer. A machine learning model trained specifically for “Audi” may be more accurate than a machine learning model trained using data for all manufacturers.

In some cases, it may be desired to use new logical data objects 410 for which sufficient training data may not exist. In such cases, the training data view 426 may be configured to reference data members 418 from one or more other logical data objects 410 or other data sources. In some scenarios, equivalent data members 418 may exist in different logical data objects 410 (e.g., Audi may be referenced by both a logical data object for a vehicle and by a logical data object for a customer or supplier), even though the logical data objects may be used for different purposes. A developer may configure the training data view 426 to reference data members 418 of logical data objects 410 which may be expected to evidence similar patterns as may be expected for a newly developed logical data object. As the new logical data object 410 is used, and instances are created, the training data view 426 may be updated to reference data for instances of the new logical data object.

In use, at design time, a developer or other user can define an input assistant scenario 430, and one or more artefacts used therewith. For example, the developer may define the training view 426, the recommend input member function 424, and the model APIs 446. The developer may also configure the training function 450, including selecting the algorithms 434 and data of the training data view 426 to be used therewith. If a logical data object 410 has not yet been created, or data artefacts to hold the logical data object data 414, those data artefacts can also be created at design time.

A user (e.g., an end user) can obtain recommendations using an application 460 that includes an input dialog or other functionality for obtaining recommended input values. Automatically, or in response to user actions, the application 460 can access a consumption user interface service 464. The consumption user interface service 464 can mediate requests for input recommendations, and can also mediate requests to retrieve data from, or change data in, a logical data object 410, including adding new instances of a logical data object or deleting instances of a logical data object. The consumption user interface service 464 can be a web-based, including using REST (representational state transfer) technologies, such as the OData (open data) protocol.

If a request received by the consumption user interface service 464 is for an input recommendation, the consumption user interface can access user interface metadata 468 for an input assistant function. The user interface metadata 468 can determine which recommend input function 424 is bound to a particular user interface control (e.g., input field). The consumption user interface 464 can then call the appropriate recommend input member function 424.

The recommend input member function 424 in turn can call an appropriate method of the model API 446. As part of the call, the member function 424 can pass one or more arguments, which can be values for data members 418 of one or more logical data objects 410, or which can be other data (including data entered by a user in the application 460, which data may or may not yet be part of a logical data object instance).

The model API 446 can access the trained model 438 to obtain an input recommendation, which can then be returned to the application 460 by the consumption user interface service 464.

### Example 6—Example Process for Obtaining Input Recommendation Using User Interface Controls

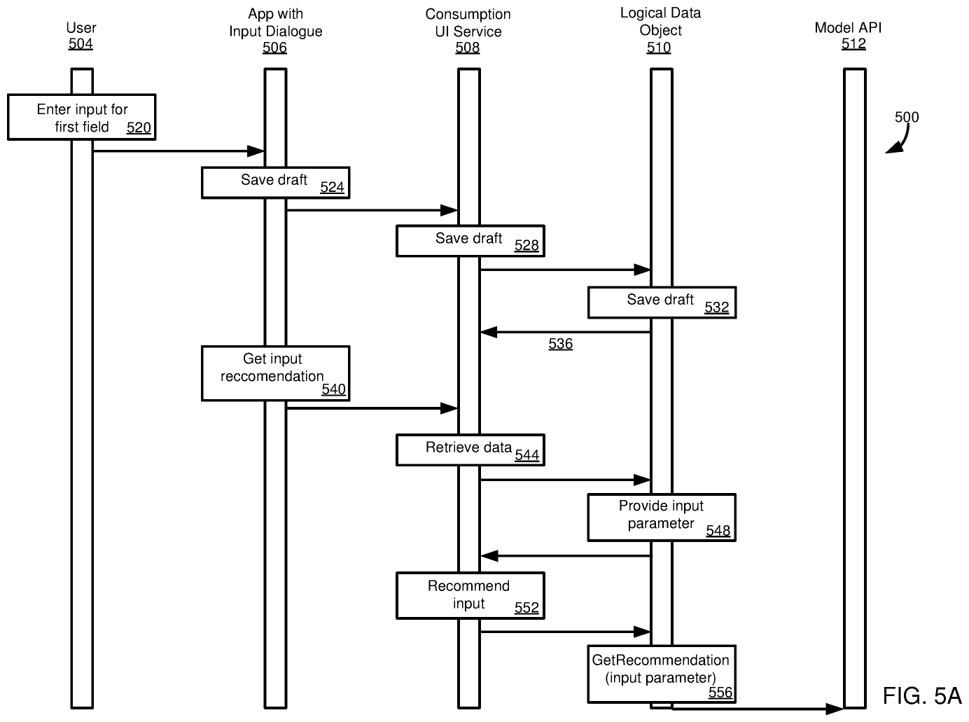

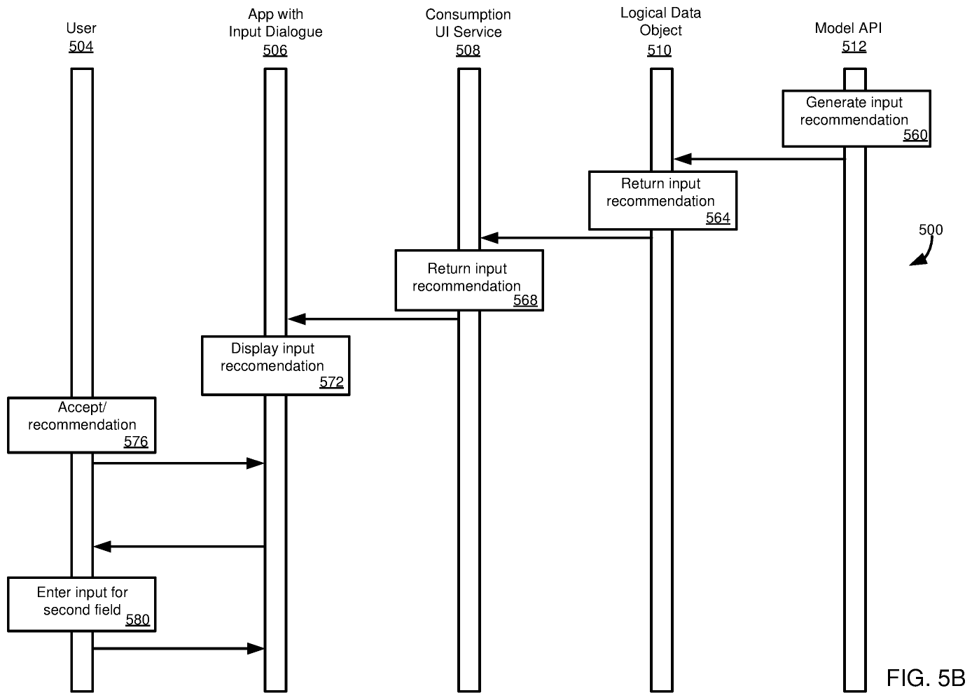

FIGS. 5A and 5B illustrate a process 500 for obtaining an input recommendation. The process 500 can be implemented using one or both of the architecture 300 of FIG. 3 or the architecture 400 of FIG. 4. The process 500 is implemented by a user 504, an application 506 that provides an input dialog or other ways for requesting an input recommendation (and which can correspond to the application 460 of FIG. 4), a consumption user interface service 508 (which can correspond to the consumption user interface service 464), a logical data object 510 (e.g., the logical data object 410), and a model API 512 (which can be an API of the model APIs 446).

At 520, the user 504 provides input for a first field of a user interface screen provided by the application 506. The application 506, at 524, can send a request to the consumption user interface service 508 to save a draft of a logical data object that includes input provided by the user. The consumption user interface service 508 processes the request to save a draft of the logical data object 510 at 528, and calls a member function of the logical data object to update a value for the appropriate data member of the logical data object.

The member function of the logical data object 510 executes at 532, saving the logical data object with the input provided by the user. In some cases, the changes to the logical data object 510 are committed when the member function is called, which can include propagating the changes to a data store (e.g., a relational database system) that stores data for the logical data object. In other cases, changes to the logical data object 510 are not committed until additional action is taken, such as upon user approval of a change. Logs, such as undo logs, can be used to restore a prior version of the logical data object 510. After the member function completes, the logical data object 510 can send a return message 536 to the consumption user interface service 508, which can indicate whether the member function successfully executed, or if any errors were encountered (e.g., the user input was not a valid value for the designated data member).

At 540, the application 506 can send a request to the consumption user interface service 508 for an input recommendation. The request can be generated automatically by the application 506 (e.g., a recommendation request is automatically generated when a user loads a user interface screen, or selects a particular user interface control, such as selecting a particular input field) or can be generated in response to specific action by a user (e.g., a “get recommendation” control). The consumption user interface service 508 can generate a request at 544 for data to be used in generating an input recommendation. Generating a request can include consulting user interface metadata (e.g., the metadata 468 of FIG. 4) to determine what member function of the logical data object 510 should be called to generate the input recommendation, and can also indicate what arguments should be passed to the such member function. For example, a machine learning model may provide more accurate data if more values are provided as arguments for an inference request. Using the scenario from Example 3, a request for a transmission type recommendation for a vehicle can be more accurate if both the make and model of the vehicle are specified, even though potentially less accurate recommendations could still be provided if only the make or model was provided as an argument. Input data can be retrieved from the logical data object 510 using an appropriate member function (e.g., “getVehicleMake( )”).

The logical data object 510 processes the input request at 548 and returns the requested values to the consumption user interface service 508. The consumption user interface service 508 can then, at 552, call the appropriate “recommend input” member function of the logical data object 510. The logical data object 510 executes the recommend input member function at 556, calling the model API 512, including passing arguments to the appropriate method of the API.

Turning to FIG. 5B, the model API 512 processes the input request at 560. The result of processing the input request can be one or more input recommendations, which can be associated with indicators of how accurate the recommendations may be. The indicators can be, for example, confidence values. In some cases, multiple input recommendations can be returned in response to an input request. When multiple input recommendations are returned, they can be returned in a ranked order or can be returned with their associated confidence values or other indicators of likely accuracy. The input recommendations are returned to the input recommendation member function of the logical data object. At 564 the recommendations are returned by the recommendation member function of the logical data object 510 to the user interface consumption service 508. In turn, the consumption user interface service 508 returns one or more input recommendations to the application 506 at 568. Prior to retuning the one or more input recommendations, the consumption user interface service 508 can take additional actions, such as returning a subset (including a single result, or no result, such as if no result meets a minimum confidence level) of the recommendations or ranking the recommendations. The recommendations can be displayed by the application 506 at 572.

In some implementations, a user is provided with an option to accept or reject an input recommendation. In more particular examples, a user must affirmatively confirm a recommendation before it will be used. User input accepting or rejecting an input recommendation is provided to the application 506 at 576. The application 576 can then take appropriate action. If the user accepts an input recommendation, the recommendation can be displayed in a user interface. Optionally, the application 576 can also save a draft of the logical data object 510, or can cause the updates to the logical data object to be committed.

Different input fields can be associated with different recommendation member functions of the logical data object 510. If user input is provided for additional user input fields, the actions described for the first user input 520 can be carried out for such additional input fields, such as when user input is provided at 580 for a second user input field.

### Example 7—Example Scenario with Input Recommendation Feature

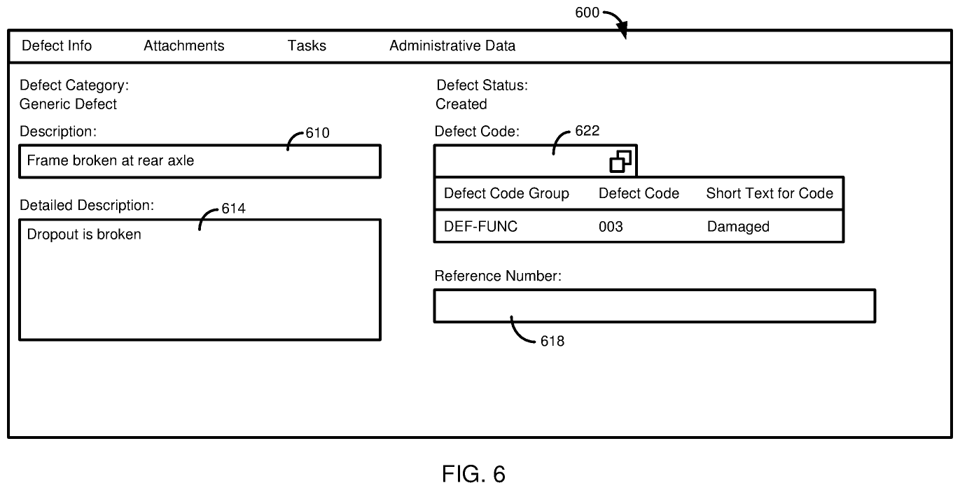

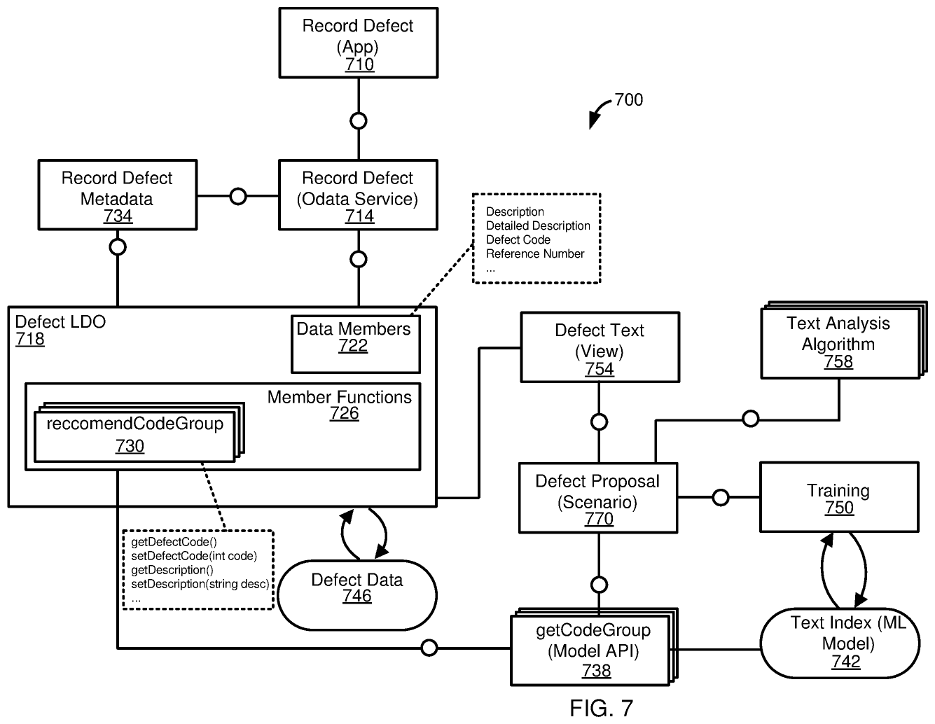

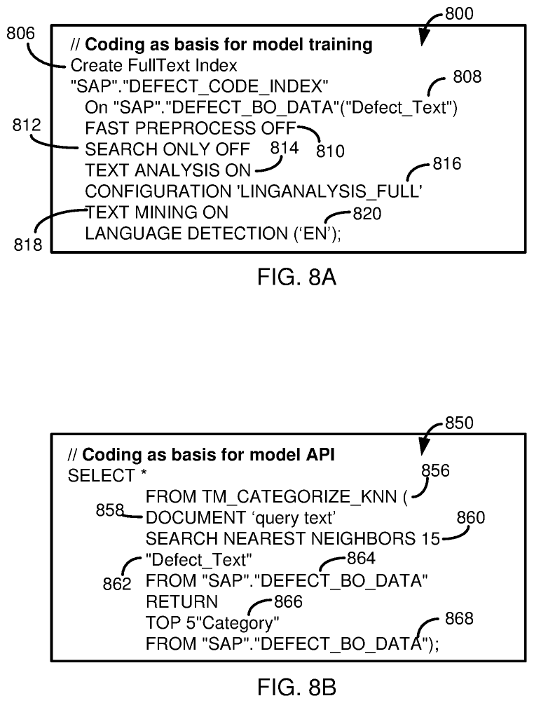

FIGS. 6-8 relate to a specific example of how disclosed technologies can be used, in the context of providing an input recommendation for a defect code group value, which can be a field of a graphical user interface through which a user can enter defect information, such as relating to defects that may occur in a manufacturing process. FIG. 6 is an example user interface screen 600 that includes input fields, at least one of which can be associated with input assistant functionality (i.e., for obtaining an input recommendation). FIG. 7 illustrates a computing architecture 700 that can be used to provide input recommendation requests associated with the user interface screen 600. FIG. 8A presents an example training data view definition 800 that can be used to obtain data associated with one or more logical data objects for training a machine learning model that can provide input recommendations. FIG. 8B provides example code 850 for a model API that can be used to obtain an input recommendation using a model trained at least in part using at least a portion of the data defined by the code 800 of FIG. 8A.

Referring first to FIG. 6, the user interface screen 600 includes a number of user interface controls, including a field 610 where a user can enter a brief description of a defect, a field 614 where a user can enter a detailed description of a defect, and a field 618 where a user can enter a reference number for the defect incident. The user interface screen 600 also include a field 622 where a user can provide a defect code. The defect code can represent a general type or category of the defect, and can be trigger one or more actions. For example, selecting a particular defect code may cause the defective item to be discarded and a production order generated to produce a new item.

Particularly for new users, it can be complicated to remember which defect code group value should be used for a particular type of defect. Part of the complexity can arise when defect codes have numerical values, as the numerical value may not convey a semantic meaning to help a user select a correct defect code group value. That is, defect code group “3” may not intuitively convey to a user what type of defect should be assigned the value “3,” or what results are obtained by selecting “3.”

Accordingly, the field 622 can be associated with an input assistant, where an input recommendation can be obtained for the field 622. In some cases, the input recommendation is obtained dynamically. For example, as a user provides values for the fields 610, 614, the application can cause input recommendations requests to be generated, and the results can be displayed in association with the field 622. Or, an input recommendation can be generated if the user selects (e.g., clicks on) the field 622. In a yet further embodiment, a user interface control can be provided to obtain a recommendation for the field 622. In cases where a user interface screen has multiple user interface controls that are associated with input recommendations, each control can be associated with another control to obtain an input recommendation for that specific control, or a single control can be provided that will obtain input recommendations for multiple controls of the user interface screen.

Turning now to FIG. 7, the computing architecture 700 can be generally similar to the computing architecture 400 of FIG. 4. However, the computing architecture 700 has components that are specifically configured for the use case of this Example 7. The computing architecture 700 includes a record defect application 710, which can be an application specific for recording defects or can be a particular process or user interface screen of an application that provides functionality in addition to allowing defects to be recorded. The record defect application 710 can thus be a specific example of the application 460.

The record defect application 710 can communicate with a record defect user interface consumption service 714, which can be a specific example of the user interface consumption service 464. The record defect user interface consumption service 714 can be implemented using the OData protocol.

The record defect user interface consumption service 714 can access data members 722 and member functions 726 (or analogous programmatic features) of a defect logical data object 718, which can be a specific example of the logical data object 410. The record defect user interface consumption service 714 can access data member 722 of the defect logical data object 718, and can call member functions 726 of the defect logical data object, including recommendCodeGroup member function 730.

The record defect user interface consumption service 714 can access record defect metadata 734 that is associated with the record defect application 710. The record defect metadata 734 can indicate that the field 622 is associated with a recommendCodeGroup member function 730 of the defect logical data object 718. Based on the record defect metadata 734, the record defect user interface consumption service 714 can call the recommendCode group member function 730.

The record defect user interface consumption service 714 can then call the recommendCodeGroup member function 730 of the logical data object 718, which in turn can call the getCodeGroup model API method 738. The call to the getCodeGroup API method 738 can include arguments, such as values of the data members 722 of the defect logical data object 718, values of data members of other logical data objects, or other data, including data provided by the record defect application 710, which can correspond to other input provided by a user.

The getCodeGroup API method 738 can access a text index 742, which can be a particular machine learning model having been trained with at least a portion of data 746 associated with the defect logical data object 718, such as historical instances of such logical data object. The training can be carried out by a training component 750 (which can correspond to the training component 434) using data defined by a defect text view 754 (which can be a type of training view 426).

A defect proposal scenario 770 can organize the components/artefacts for the use case of FIG. 7, such as specifying one or more of the application 710, and its user interface control, the record defect metadata 734, the defect logical data object 718 (including the recommendCodeGroup member function 730), the getCodeGroup model API method 738, the defect text view 754, the text analysis algorithm 758, the training function 750, or the text index 742.

FIG. 8A presents example code 800 that can be used by the training component 750 for producing the text index 742. The code 800, at line 808, references a DEFECT_BO_DATA view, which can be the defect text view 754. Line 806 can reference a text mining algorithm, which serves as a text analysis algorithm 758. Lines 810-820 specify parameters for use by the text mining algorithm.

The getCodeGroup API method 738 can access the text index 742. FIG. 8B provides example code 850 for the getCodeGroup API method 738. Line 856 specifies that the k-nearest neighbors classifier should be used, and line 860 species a parameter for the k-nearest algorithm, that k should be set to 15. Line 858 specifies that “query text,” which can correspond to data for a logical data object associated with the recommend input request (e.g., the input provided by the user for the field 610 or the field 614 of FIG. 6). Lines 862, 864 specify that the “defect text” data member of the DEFECT_BO_DATA logical data objects used in the model should be used for the k-nearest neighbors classifier. Lines 866, 868 specifies that the top give matching classification results should be returned by the getCodeGroup API method 738.

### Example 8—Example Implementations for User Interface Controls Associated with an Input Recommendation Feature

An input assistant using disclosed technologies can operate in a variety of ways, including whether input recommendations are provided prior to receiving user input providing a proposed value for a user interface control associated with an input recommendation, or upon selecting such a field, upon receiving such input, or in response to receiving an explicit user request for an input recommendation (which can be made with or without a user-supplied value having been provided).

When a user interface includes multiple user interface controls, such as input fields, not all controls need be associated with an input recommendation. As described in the discussion of FIG. 6, for example, input fields 610, 614 may not be associated with an input recommendation, although field 622 is. Moreover, although input recommendations are not provided for input fields 610, 614, information for those fields can be used in generating an input recommendation for input field 622.

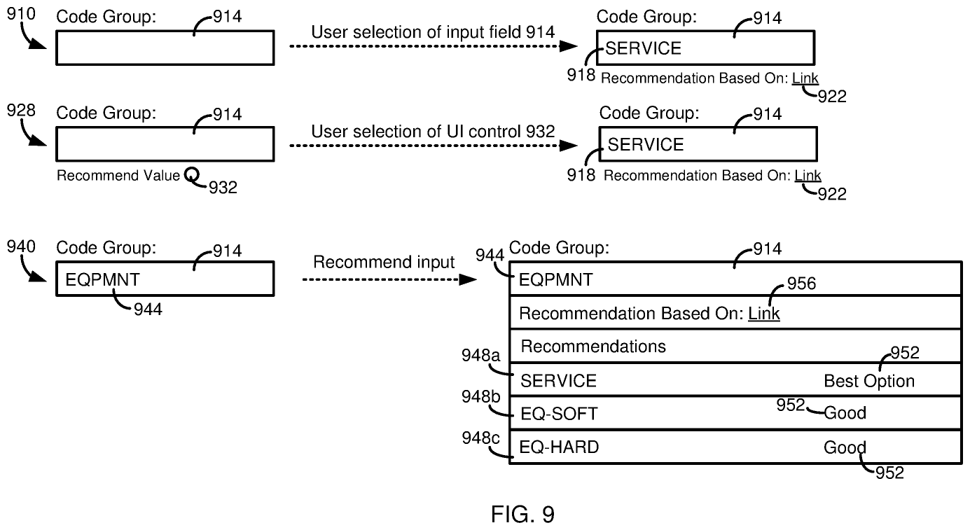

FIG. 9 provides examples of how user interface controls may provide input recommendations, optionally including information regarding how a recommendation was determined, or providing the option to access such information. The examples of FIG. 9 can correspond to options for displaying the input field 622 of FIG. 6.

Example 910 represents a scenario where an input recommendation is requested and displayed when a user selects input field 914 (corresponding to input field 622). Initially, the input field 914 is unpopulated. When a user selects (e.g., clicks in) the input field 914, an input recommendation request is triggered, such as described in Example 6. Input field 914 is then populated with a recommended value 918, such a top-ranked value. Optionally, a link 922 can be provided that provides a user with information regarding why a particular value was recommended, and can optionally provide other values that were returned in response to an input recommendation request. This explanation information can be implemented as described in Examples 18-25.

Example 928 represents a scenario where an input recommendation is requested in response to a user request, such as a user selecting a control 932 to obtain an input recommendation. In this case, the recommended input 918 and link 922 are provided when the user selects the control 932. If the user selects the input field 914, or types a value in the input field, an input recommendation is not automatically requested.

Example 940 represents a scenario where a user has entered a value 944 for the input field 914, and a recommend input method has been called, which can be called in response to a user completing an entry (e.g., hitting “enter”) or selecting a control analogous to the control 932. In this case, the user interface screen continues to display the value 944 entered by the user, along with recommended values 948a-948c. The recommended values 948a-948c are shown with qualitative indicators 952 of how likely the given value is likely to be the value desired by the user. Again, the qualitative indicators 952 can be determined and implemented as described in Examples 18-25. If desired, a link 956, analogous to the link 922, can be provided to allow a user to obtain additional explanatory information regarding the basis for a recommendation.

In other implementations, more or less explanatory information may be displayed in Example 940. For instance, the user interface may display the link 956, but the not the qualitative indicators 952, or may display the qualitative indicators but not the link 952. Or, the user interface may omit explanatory information or controls for obtaining explanatory information.

In the scenario 940, a user can select to retain the originally entered value 944, or can select one of the recommended values 948a-948c.

In some cases, a user must affirmatively select a recommend input (e.g., the values 918 or one of the values 948-948c). In other cases, recommended values can be used so long as they are not removed or altered by a user. In addition, although Examples 1 and 3-10 describe the use of disclosed technologies as part of input recommendations presented to a user, the technologies can also be applied to generate values for use without user input being required. For example, logical data object instances can be generated automatically, at least in part, where values for at least some data members are obtained using input recommendation methods associated with the logical data object. Or, values can be determined for the data members after an instance has been instantiated.

### Example 9—Example Processes Using Input Recommendations

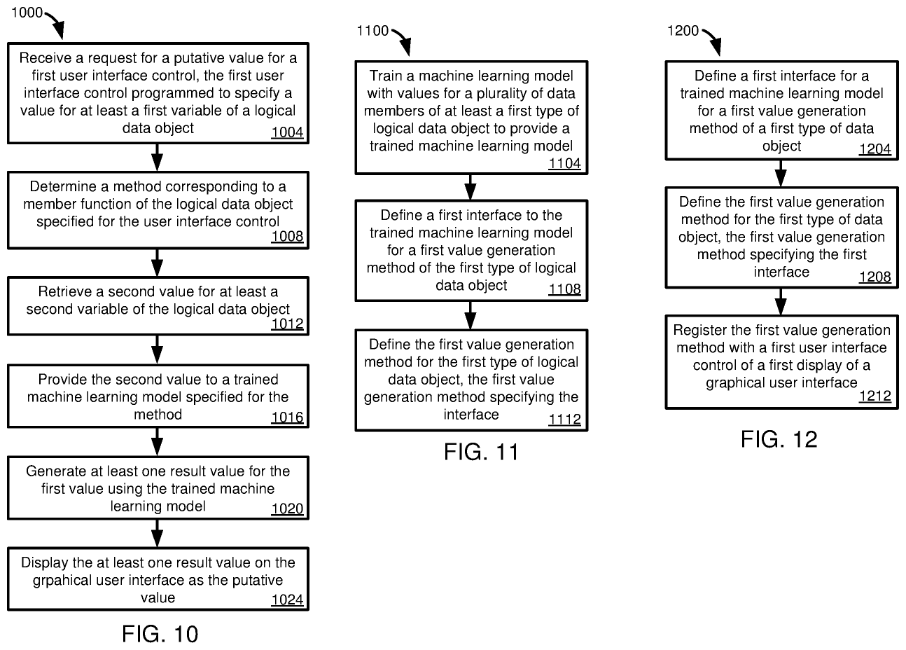

FIG. 10 is a flowchart of a method 1000 of obtaining a recommended value for a user interface control of a graphical user interface. The method 1000 can be carried out in the computing environment 300 of FIG. 3 or the computing environment 400 of FIG. 4, and can use the process 500 described in conjunction with FIGS. 5A and 5B.

At 1004, a request is received for a putative value for a first user interface control of a graphical user interface. The putative value can be a recommended value and the request can be an input recommendation request. A method is determined at 1008 that is specified for the user interface control. The method can be a member function of a logical data object that includes a plurality of variables, such as data members, and can be an input recommendation method. The user interface control is programmed to specify a first value for at least a first variable of the plurality of variables.

At 1012, a second value is retrieved for at least a second variable of the plurality of variables. The second value is provided, at 1016, to a trained machine learning model specified for the method. At 1020, at least one result value is generated for the first value using the trained machine learning model. The at least one result value is displayed on the graphical user interface as the putative value at 1024.

FIG. 11 is a flowchart of an example method 1100 of defining an input recommendation method for a logical data object. The method 1100 can be carried out in the computing environment 300 of FIG. 3 or the computing environment 400 of FIG. 4.

At 1104, a machine learning model is trained with values for a plurality of data members of at least a first type of logical data object to provide a trained machine learning model. A first interface to the trained machine learning model is defined at 1108 for a first value generation method (i.e., an input or value recommendation method) of the first type of logical data object. The first value generation method for the first type of logical data object is defined at 1112. The first value generation method specifies the first interface.

FIG. 12 is a flowchart of a method 1200 of registering an input recommendation method with a user interface control of a display of a graphical user interface. The method 1200 can be carried out in the computing environment 300 of FIG. 3 or the computing environment 400 of FIG. 4.

At 1204, a first interface is defined for a trained machine learning model for a first value generation method (e.g., an input or value recommendation method) of a first type of data object (such as a logical data object). The machine learning model has been trained by processing data for a plurality of instances of the first type of data object with a machine learning algorithm. The first value generation method for the first type of data object is defined at 1208. The first value generation method specifies the first interface. At 1212, the first value generation method is registered with a first user interface control of a first display of a graphical user interface.

### Example 10—Example Machine Learning Scenarios Providing Model Segments and Customizable Hyperparameters

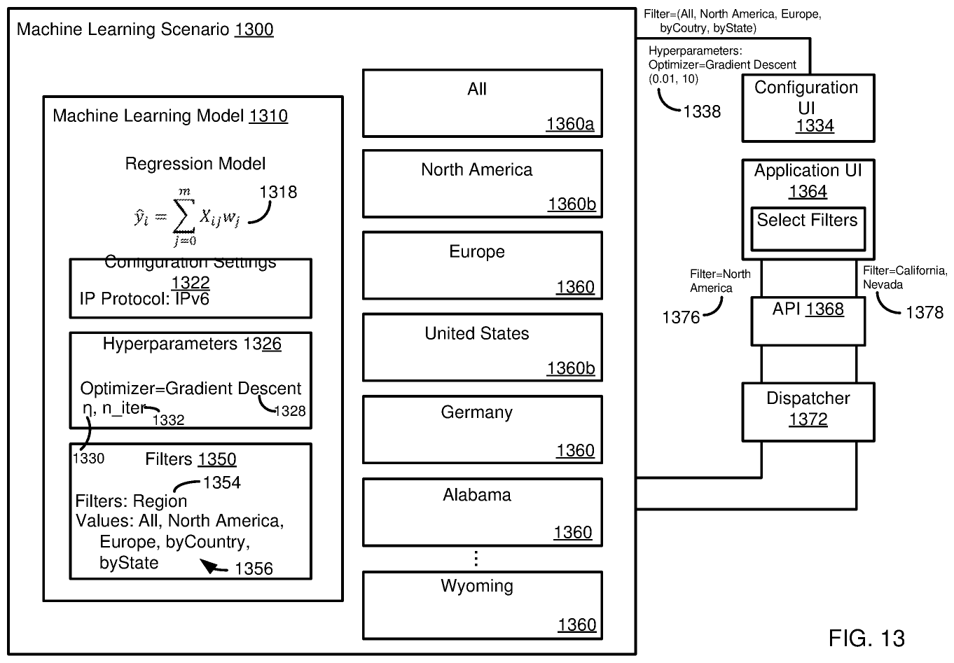

FIG. 13 is a diagram illustrating a machine learning scenario 1300 where a key user can define hyperparameters and model segment criteria for a machine learning model, and how these hyperparameters and model segments created using the model segment criteria can be used in inference requests by end users. Although shown as including functionality for setting hyperparameters and model segment criteria, analogous scenarios can be implemented that include functionality for hyperparameters, but not model segment criteria, or which include functionality for model segment criteria, but not hyperparameters.

The machine learning scenario 1300 includes a representation of a machine learning model 1310. The machine learning model 1310 is based on a particular machine learning algorithm. As shown, the machine learning model 1310 is a linear regression model associated with a function (or algorithm) 1318. In some cases, the machine learning scenario 1300 includes a reference (e.g., a URI for a location of the machine learning model, including for an API for accessing the machine learning model).

The machine learning model 1310 can be associated with one or more configuration settings 1322. Consider an example where the machine learning model 1314 is used to analyze patterns in traffic on a computer network, including patterns associated with particular geographic regions. A configuration setting 1322 can include whether the network protocol uses IPv4 or IPv6, as that can affect, among other things, the number of characters expected in a valid IP address, as well as the type of characters (e.g., digits or alphanumeric). In the case where the machine learning model 1314 is provided as an “out of the box” solution for network traffic analysis, the configuration settings 1322 can be considered a setting that is not intended to be altered by a key user, and it is a basic setting/parameter for the machine learning model, rather than being used to tune model results.

The machine learning model 1314 can further include one or more hyperparameters 1326. The hyperparameters 1326 can represent parameters that can be used to tune the performance of a particular machine learning model. One hyperparameter is an optimizer 1328 that can be used to determine values for use in the function 1318 (e.g., for w). As shown, the gradient descent technique has been selected as the optimizer 1328. The optimizer 1328 can itself be associated with additional hyperparameters, such as, η, a learning rate (or step size) 1330 and a number of iterations 1332, “n_iter.”

The values of the hyperparameters 1326 can be stored. Values for hyperparameters 1326 can be set, such as by a key user using a configuration user interface 1334. The scenario 1300 shows hyperparameter settings 1338 being sent by the configuration user interface 1334 to be stored in association with the regression model 1314. In addition to setting the optimizer to “gradient descent,” the hyperparameters settings 1338 set particular values for η and for the number iterations to be used.

Particular values for the hyperparameters 1326 can be stored in a definition for the machine learning model 1314 that is used for a particular machine learning scenario 1300. For example, a machine learning scenario 1300 can specify the function 1318 that should be used with the model, including by specifying a location (e.g., a URI) or otherwise providing information for accessing the function (such as an API call). The definition can also include values for the hyperparameters 1326, or can specify a location from which hyperparameter values can be retrieved, and an identifier that can be used to locate the appropriate hyperparameter values (which can be an identifier for the machine learning model scenario 1300). Although a user (or external process) can specify values for some or all of the hyperparameters 1326, a machine learning scenario 1300 can include default hyperparameters values that can be used for any hyperparameters whose values are not explicitly specified.

One or more filters 1350 can be defined for the machine learning scenario 1300. The filters 1350 can be used to define what machine learning model segments are created, what machine learning model segments are made available, and criteria that can be used to determine what machine learning model segment will be used to satisfy a particular inference request.

FIG. 13 illustrates that filters 1350 can have particular types or categories, and particular values for a given type or category. In particular, the machine learning scenario 1300 is shown as providing filters for a region type 1354, where possible values 1356 for the region type include all regions, all of North America, all of Europe, values by country (e.g., Germany, United States), or values by state (e.g., Alaska, Nevada). Although a single filter type is shown, a given machine learning scenario 1300 can include multiple filter types. In the example of network traffic analysis, additional filters 1350 could include time (e.g., traffic during a particular time of a day), a time period (e.g., data within the last week), or traffic type (e.g., media streaming). When multiple filter categories are used, model segments can be created for individual values of individual filters (or particular values selected by a user) or for combinations of filter values (e.g., streaming traffic in North America), where the combinations can optionally be those explicitly specified by a user (particularly in the case where multiple filter types and/or multiple values for a given type exist, which can vastly increase the number of model segments).

Model segments 1360 can be created using the filters 1350. As shown, model segments 1360 are created for the possible value of the region filter type 1354, including a model segment 1360a that represents an unfiltered model segment (e.g., includes all data). In some cases, the model segment 1360a can be used as a default model segment, including in an inference request that is received that includes parameters that cannot be mapped to a more specific model segment 1360.

When an end user wishes to request an inference (that is, obtain a machine learning result, optionally included an explanation as to its practical significance, for a particular set of input data), the user can select a data set and optionally filters using an application user interface 1364. In at least some cases, filters (both types and possible values) presented in the application user interface 1364 correspond to filters 1350 (including values 1356) defined for a given machine learning scenario 1300 by a key user. Available filters 1350, and possibly values 1356, can be read from a machine learning scenario 1300 and used to populate options presented in the application user interface 1364.

In other cases, the application user interface 1364 can provide fewer, or no, constraints on possible filter types 1354 or values 1356 that can be requested using the application user interface 1364. When an interference request is sent from the application user interface 1364 for processing, a dispatcher 1372 can determine one more model segments 1360 that may be used in processing the request, and can select a model segment (e.g., based on which model segment would be expected to provide the most accurate or useful results). If no suitable model segment 1360 is found, an error can be returned in response to the request. Or a default model segment, such as the model segment 1360a, can be used.

The inference request can be sent to an application program interface 1368. The application program interface 1368 can accept inference requests, and return results, on behalf of the dispatcher 1372. The dispatcher 1372 can determine for a request received through the API 1368 what model segment 1360 should be used for the request. The determination can be made based on filter values 1356 provided using the application user interface 1364.

As an example, consider a first inference request 1376 that includes a filter value of “North America.” The dispatcher 1372 can determine that model segment 1360b matches that filter value and can route the first inference request 1376 to the model segment 1360b for processing (or otherwise cause the request to be processed using the model segment 1360b). A second inference request 1378 requests that data be used for California and Nevada. The dispatcher 1372 can review the available model segments 1360 and determine that no model segment exactly matches that request.

The dispatcher 1372 can apply rules to determine what model segment 1360 should be used for an inference request when no model segment exactly matches request parameters. In one example, model segments 1360 can have a hierarchical relationship. For instance, filter types 1354 or values 1356 can be hierarchically organized such that “North America” is known to be a subset of the “all values” model segment 1360a. Similarly, the filter values can be organized such that a U.S. state is known to be a subset of “United States,” where in turn “United States” can be a subset of “North America.” If no model segment 1360 matches a given level of a filter hierarchy, the next higher (e.g., more general, or closer to the root of the hierarchy) can be evaluated for suitability.

For the second inference request 1378, it can be determined that, while segments models 1360 may exist for California and Nevada separately; no model exists for both (and only) California and Nevada. The dispatcher 1372 can determine that a segment model 1360d for “United States” is a model segment higher in the filter hierarchy that is that most specific model segment that includes data for both California and Nevada. While the model segment 1360b for North America also includes data for California and Nevada, it is less specific than the model segment 1360d for the United States.

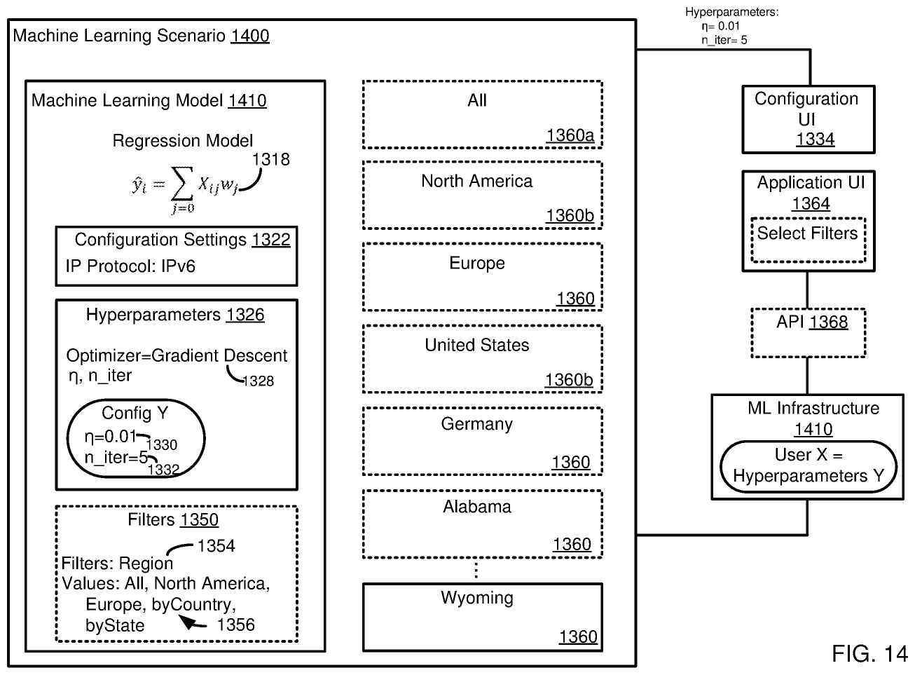

FIG. 14 illustrates a machine learning scenario 1400 that is generally similar to the machine learning scenario 1300 of FIG. 13 and illustrates how hyperparameter information can be determined for a given inference request. Assume that a user enters an inference request using the application user interface 1364. Machine learning infrastructure 1410 can determine whether the inference request is associated with particular hyperparameters values or if default values should be used. Determining whether a given inference request is associated with specific hyperparameters can include determining a particular user or process identifier is associated with specific hyperparameter values. Information useable to determine whether an inference request is associated with specific hyperparameter values can optionally be included in a call to the application program interface 1368 (e.g., the call can include as arguments one or more of a process ID, a user ID, a system ID, a scenario ID, etc.). If no specific hyperparameter values are found for a specific inference request, default values can be used.

There can be advantages to implementations where functionality for model segments is implemented independently of functionality for hyperparameters. That is, for example, a given set of trained model segments can be used with scenarios with different hyperparameter values without having to change the model segments or a process that uses the model segments. Similarly, the same hyperparameters can be used with different model segments or interference request types (e.g., a given set of hyperparameters can be associated with multiple machine learning scenarios 1300), so that hyperparameter values do not have to be separately defined for each model segment/inference request type.

### Example 11—Example Process for Training and Use of Machine Learning Model Segments

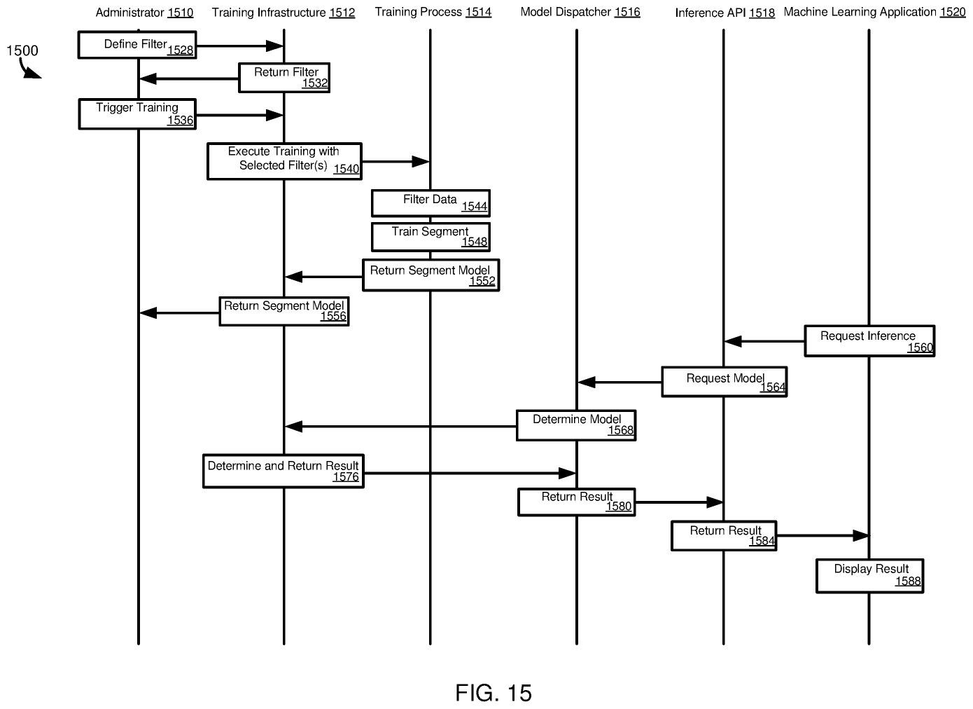

FIG. 15 is a timing diagram illustrating an example process 1500 for defining and using model segments. The process 1500 and can represent a particular instance of the scenario 1300 of FIG. 13.

The process 1500 can be carried out by an administrator 1510 (or, more technically, an application that provides administrator functionality, such as to a key user), a training infrastructure 1512, a training process 1514, a model dispatcher 1516, an inference API 1518, and a machine learning application 1520

Initially, the administrator 1510 can define one or more filters at 1528. The one or more filters can include one or more filter types, and one or more filter values for each filter type. In at least some cases, the filter types, and values, correspond to attributes of a data set to be used with a machine learning model, or metadata associated with such a data set. In the case where data (input or training) is stored in relational database tables, the filter types can correspond to particular table attributes, and the values can correspond to particular values found in the data set for those attributes. Or, the filter types can correspond to a dimensional hierarchy, such as associated with an OLAP cube or similar multidimensional data structure.

The filters defined at 1528 are sent to the training infrastructure 1512. The training infrastructure 1512, at 1532, can register the filters in association with a particular machine learning model, or a particular scenario (which can have an identifier) that uses the model. The model/scenario can be used, for example, to determine which filter (and in some cases filter values) should be displayed to an end user for generating an inference request. While in some cases filter values can be explicitly specified, in other cases they can be populated from a data set based on filter types. For example, if a filter type is “state,” and a data set includes only data for Oregon and Arizona, those values could be provided as filter options, while filter values for other states (e.g., Texas) would not be displayed as options. An indication that the filter has been defined and is available for use can be sent from the training infrastructure 1512 to the administrator 1510.

At 1536, the administrator 1510 can trigger training of model segments using the defined filter by sending a request to the training infrastructure 1512. The training infrastructure 1512 can use the requested filters to define and execute a training job at 1540. The training job is sent to the training process 1514. The training process 1514 filters training data at 1544 using the defined filters. The model segment is then trained using the filtered data at 1548. The segment models are returned (e.g. registered or indicated as active) to the training infrastructure 1512 by the training process 1514 at 1552. At 1556, the segment models are returned by the training infrastructure 1512 to the administrator 1510.

The machine learning application 1520 can request an inference at 1560. The inference request can include an identification of one or more filter types, having one more associated filter values. The inference request is sent from the machine learning application 1520 to the inference API 1518. At 1564, the inference API 1518 forwards the inference request to the model dispatcher 1516. The model dispatcher 1516, at 1568, determines a model segment to be used in processing the inference request. The determination can be made based on the filter types and values included in the inference request from the machine learning application 1520, and can be carried out as described for the scenario 1300 of FIG. 13.

The model dispatcher 1516 sends the inference request to the training infrastructure 1512, to be executed on the appropriate model segment (as determined by the model dispatcher). The training infrastructure 1512 determines a machine learning result, which can include an inference drawn from the result, at 1576, and sends the result to the model dispatcher 416, which in turn returns the result at 1580 to the API 1518, and the API can return the result to the machine learning application 1520 at 1584. The machine learning application 1520 can display the machine learning result, such as to an end user, at 1588.

### Example 12—Example Data Artefact Including Model Segment Filters

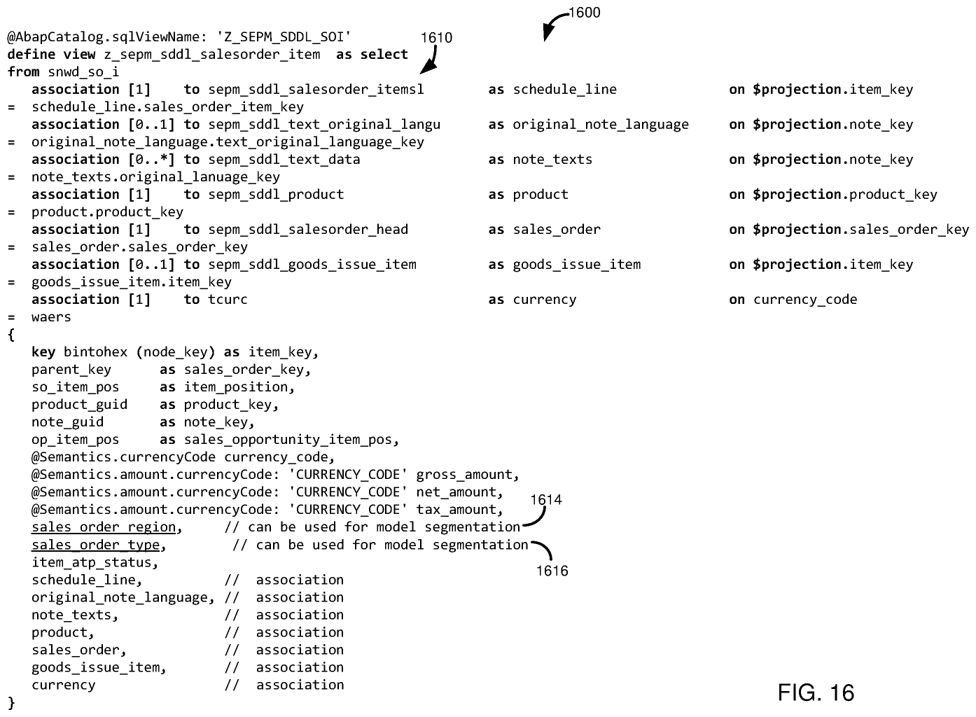

FIG. 16 illustrates an example definition 1600 for a data artefact, such as a data artefact of a virtual data model, illustrating how segmentation information can be provided. The definition is a Core Data Service view definition, as used in products available from SAP SE, of Walldorf, Germany.

The definition 1600 includes code 1610 defining data referenced by the view, which can be used to construct a data artefact in a database (e.g., in a data model for the data, such as in an information schema or data dictionary for a physical data model for the database) corresponding to the view. The definition 1600 includes elements 1614, 1616, which are attributes (in this case, non-key attributes) that can be used for model segmentation. In some cases, the elements 1614, 1616 can represent elements that a key user can select for creating model segments. In other cases, the elements 1614, 1616 represent filters that have been defined for a model, and for which corresponding model segments have been created (e.g., using the process 1500 of FIG. 15). Generally, key or non-key attributes included in the definition 1600 can be used to define model segments.

### Example 13—Example User Interface Screens for Configuring Machine Learning Models

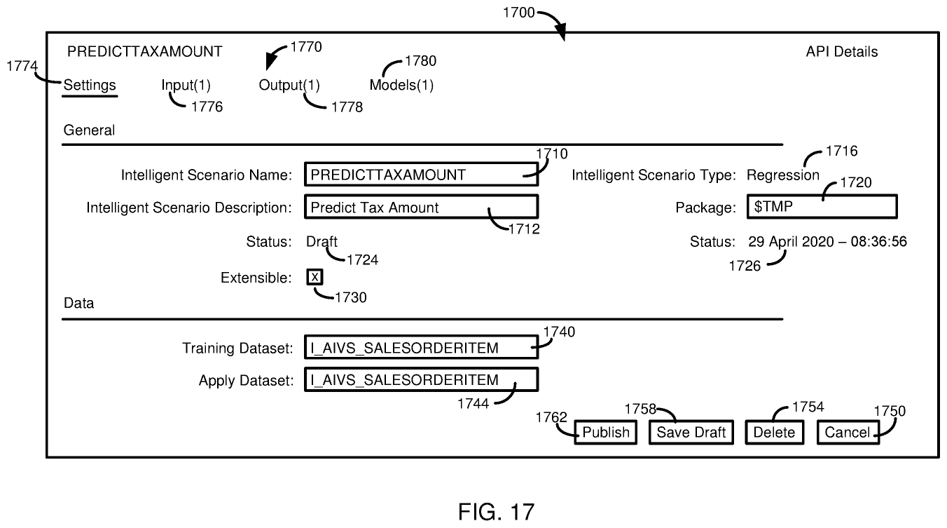

FIGS. 17-20 provide a series of example user interface screens illustrating how a machine learning scenario (e.g., a particular application of a particular machine learning model) can be configured to use disclosed technologies. The screens can represent screens that are provided to a key user, such as in the configuration user interface 1334 of FIG. 13 or FIG. 14.

FIG. 17 provides an example user interface screen 1700 that allows a user to provide basic definitional information for a machine learning scenario, including entering a name for the scenario in a field 1710 and a description for the scenario in a field 1712. A field 1716 provides a type for the scenario, which can represent a particular machine learning algorithm that is to be used with the scenario. In some cases, the field 1716 can be linked to available machine learning algorithms, such that a user may select from available options, such as using a drop down menu.

A package, which can serve to contain or organize development objects associated with the machine learning scenario, can be specified in a field 1720. In other cases, the package can indicate a particular software package, application, or application component with which the scenario is associated. For example, the value in the field 1720 can indicate a particular software program with which the scenario 1700 is associated, where the scenario can be an “out of the box” machine learning scenario that is available for customization by a user (e.g., a key user).

A status 1724 of the scenario can be provided, as can a date 1726 associated with the status. The status 1724 can be useful, such as to provide an indication as to whether the scenario has already been defined/deployed and is being modified, or if the scenario is currently in a draft state. A user can select whether a scenario is extensible by selecting (or not) a check box 1730. Extensible scenarios can be scenarios that are customizable by customers/end users, where extensible customizations are configured to be compatible with any changes/updates to the underlying software. Extensible scenarios can allow for changes to be made such as changing a machine learning algorithm used with the scenario, extending machine learning logic (such as including transformations or feature engineering), or extending a consumption API for a model learning model.

One or more data sets to be used with the machine learning scenario can be selected (or identified) using fields 1740, 1744, for training data and inference data, respectively.

Once a scenario has been defined/modified, a user can choose to take various actions. If a user wishes to discard their changes, they can do so by selecting a cancel user interface control 1750. If a user wishes to delete a scenario (e.g., a customized scenario) that has already been created, they can do so by selecting a delete user interface control 1754. If the user wishes to save their changes, but not activate a scenario for use, they can do so by selecting a save draft user interface control 1758. If the user wishes to make the scenario available for use, they can do so by selecting a publish user interface control 1762.

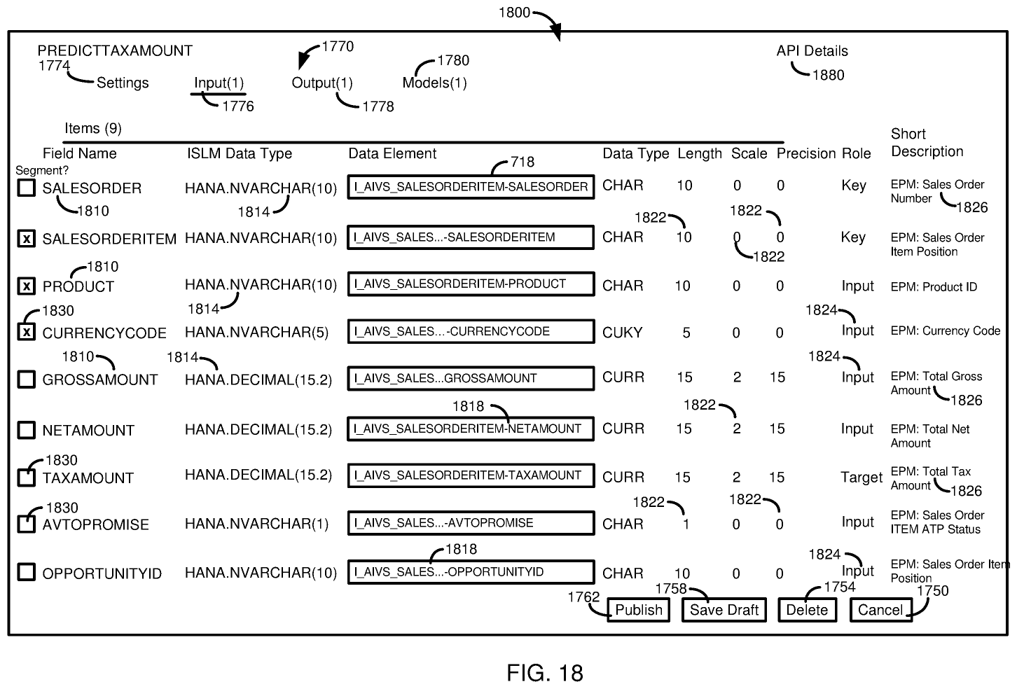

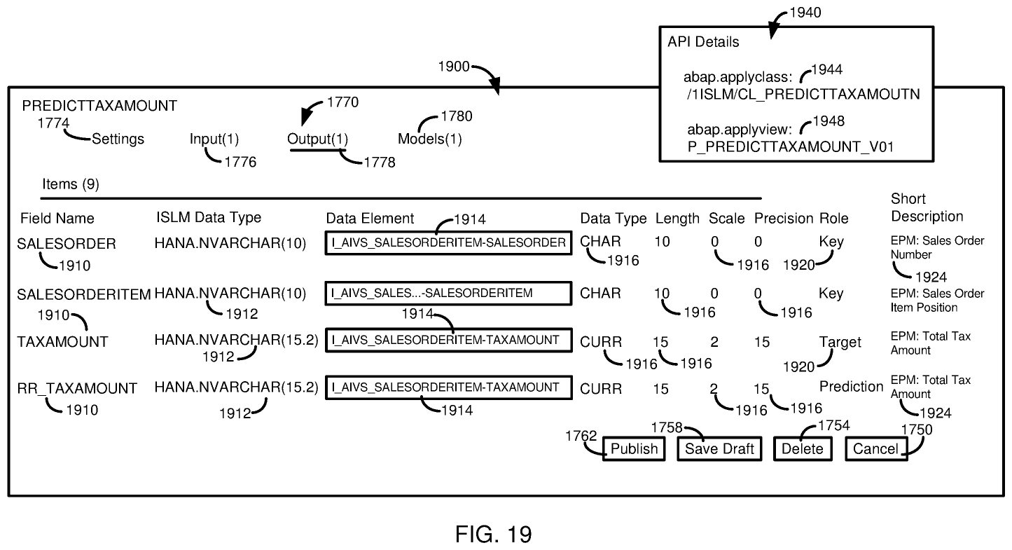

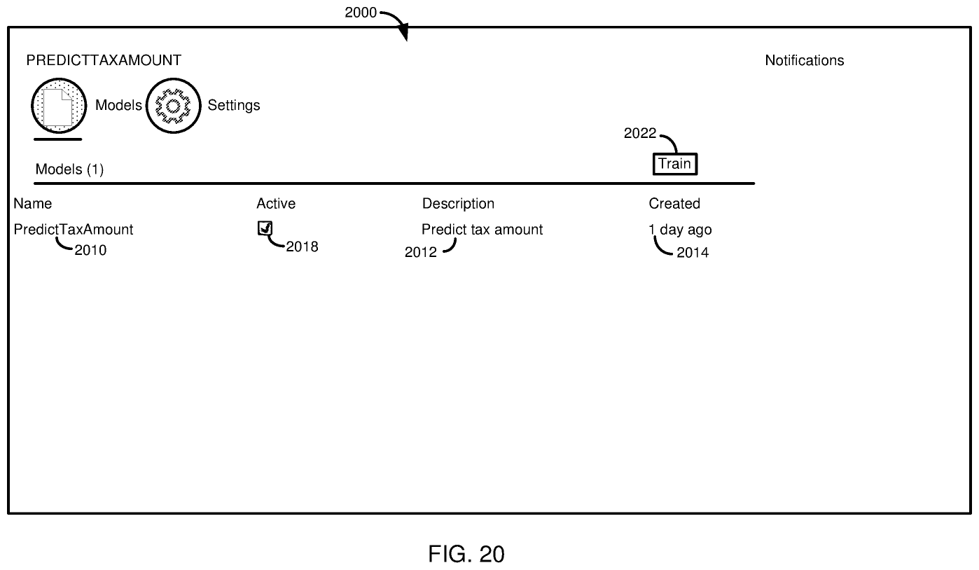

Navigation controls 1770 can allow a user to navigate between the screens shown in FIGS. 17-20, to define various aspects of a scenario. The scenario settings screen 1700 can be accessed by selecting a navigation control 1774. An input screen 1800, shown in FIG. 18, can be accessed by selecting a navigation control 1776. An output screen 1900, shown in FIG. 19, can be accessed by selecting a navigation control 1778. A screen 2000, shown in FIG. 20, providing information for models used in the scenario, can be accessed by selecting a navigation control 1780.

FIG. 18 presents a user interface screen 1800 that allows a user to view attributes that are used to train a model used for the scenario. In some cases, the attributes are pre-defined for a given scenario, but are expected to match the training or inference (e.g. input/apply) data sets specified using the fields 1740, 1744 of FIG. 17. In other cases, the attributes are populated based on the data sets specified using the fields 1740, 1744.

For each attribute, the user interface screen 1800 lists the name 1810 of the field, the data type 1814 used by the machine learning model associated with the scenario, a data element 1818 (e.g., a data element defined in a data dictionary and associated with the attribute, where a data element can be a data element as implemented in products available from SAP SE, of Walldorf, Germany) of the source data set (which type can be editable by a user), details 1822 regarding the data type (e.g., a general class of the data type, such as character or numerical, a maximum length, etc.), a role 1824 for the attribute (e.g., whether it acts as a key, or unique identifier, for data in a data set, serves as a non-key input, or whether it is an attribute whose value is to be predicted using a machine learning algorithm), and a description 1826 for the attribute.

In a specific implementation, a user may select attributes of the user interface screen 1800 to be used to define model segments. For example, a user may select attribute to be used for model segment definition by selecting a corresponding checkbox 1830 for the attribute. In the implementation shown, attributes selected using checkboxes 1830 can be used to define filter types or categories. An underlying data set can be analyzed to determine particular filter values that will be made available for a given data set. In other cases, the user interface screen 1800 can provide an input field that allows a user to specify particular values for attributes used for model segmentation.

The user interface screen 1800 can include the navigation controls 1770, and options 1750, 1754, 1758, 1762 for cancelling input, deleting a scenario, saving a draft of a scenario, or publishing a scenario, respectively.

The user interface screen 1900 can be generally similar to the user interface screen 1800, but is used to provide information, and optionally configure, information for attributes or other values (e.g., machine learning results) provided as output of a machine learning scenario/model.

The user interface screen 1900 displays the name 1910 for each attribute, the data type 1912 used by the machine learning algorithm, a field 1914 that lists a data element associated with the attribute (which can be edited by a user), and data type information 1916 (which can be analogous to the data type information 1822 of FIG. 18). The user interface screen 1900 can also list a role 1920 for each attribute as well as a description 1924 for the attribute. The roles 1920 can be generally similar to the roles 1824. As shown, the roles 1920 can indicate whether the output attribute identifies a particular record in a data set (including a record corresponding to a machine learning result), whether the attribute is a target (e.g., that is determined by the machine learning algorithm, as opposed to being an input value), or whether the result is a predicted value. In some cases, a predicted attribute can be an attribute whose value is determined by a machine learning algorithm and which is provided to a user as a result (or otherwise used in determining a result presented to a user, such as being used to determine an inference, which is then provided to a user). A target attribute can be an attribute whose value is determined by a machine learning algorithm, but which may not be, at least directly, provided to a user. In some cases, a particular data can have multiple roles, and can be associated with (or listed as) multiple attributes, such as being both a target attribute and a prediction attribute.

The user interface screen 1900 also shows details 1940 for an application program interface associated with the scenario being defined. The details 1940 can be presented upon selection of a user interface control (not shown in FIG. 19, but which can correspond to a control 1880 shown in FIG. 18). The details 1940 can identify a class (e.g., in an object oriented programming language) 1944 that implements the API and an identifier 1948 for a data artefact in a virtual data model (e.g., the view 1600 of FIG. 16) that specifies data to be used in generating an inference. In at least some cases, the API identified in the details 1940 can include functionality for determining a model segment to be used with an inference request, or at least accepting such information which can be used by another component (such as a dispatcher) to determine which model segment should be used in processing a given inference request. The data artefact definition of FIG. 16 can represent an example of a data artefact identified by the identifier 1948.

The user interface screen 1900 can include the navigation controls 1770, and options 1750, 1754, 1758, 1762 for cancelling input, deleting a scenario, saving a draft of a scenario, or publishing a scenario, respectively.

The user interface screen 2000 of FIG. 20 can provide information about particular customized machine learning scenarios that have been created for a given “out of the box” machine learning scenario. The user interface screen 2000 can display a name 2010 for each model, a description 2012 of the model, and a date 2014 the model was created. A user can select whether a given model is active (e.g., available for use by end users) by selecting a check box 2018. A user can select to train (or retrain) one or more models for a given scenario by selecting a train user interface control 2022. Selecting a particular model (e.g., by selecting its name 2010) can cause a transition to a different user interface screen, such as taking the user to the settings user interface screen 1700 with information displayed for the selected scenario.

### Example 14—Example User Interface Screen for Defining Machine Learning Model Segments

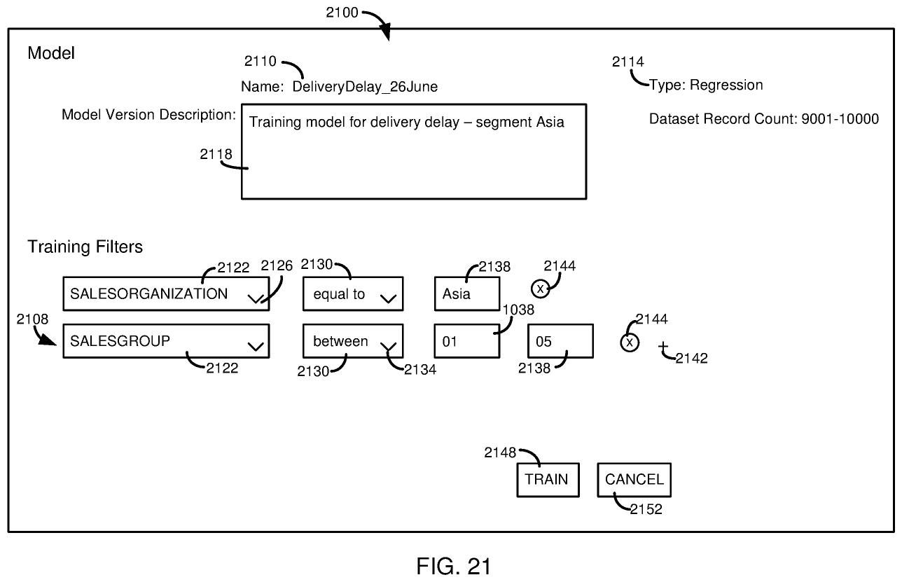

FIG. 21 provides another example user interface screen 2100 through which a user can configure filters that can be used to generate model segments that will be available to end users for requests for machine learning results. The user interface screen 2100 can display a name 2110 for the overall model, which can be specified in the screen 2100 or can be populated based on other information. For example, the screen 2100 can be presented to a user in response to a selection on another user interface screen (e.g., the user interface screen 1700 of FIG. 17) to create model segments, and the model name can be populated based on information provided in that user interface screen, or another source of information defining a machine learning model or scenario. Similarly, the screen 2100 can display the model type 2114, which can be populated based on other information. The screen 2100 can provide a field, or text entry area, 2118 where a user can enter a description of the model, for explanation purposes to other uses, including criteria for defining model segments.

A user can define various training filters 2108 using the screen 2100. Each filter 2108 can be associated with an attribute 2122. In some cases, a user may select from available attributes using a dropdown selector 2126. The available attributes can be populated based on attributes associated with a particular input or training dataset, or otherwise defined for a particular machine learning scenario. Each filter 2108 can include a condition type (e.g., equals, between, not equal to) 2130, which can be selected using a dropdown selector 2134. Values to be used with the condition 2130 can be provided in one or more fields 2138. A user may select to add additional filters, or delete filters, using controls 2142, 2144, respectively.

Once the filters 2108 have be configured, a user can choose to train one or more model segments using the filters by selecting a train user interface control 2148. The user can cancel defining model segments by selecting a cancel user interface control 2152.

### Example 15—Example User Interface Screen for Defining Custom Hyperparameters for a Machine Learning Model

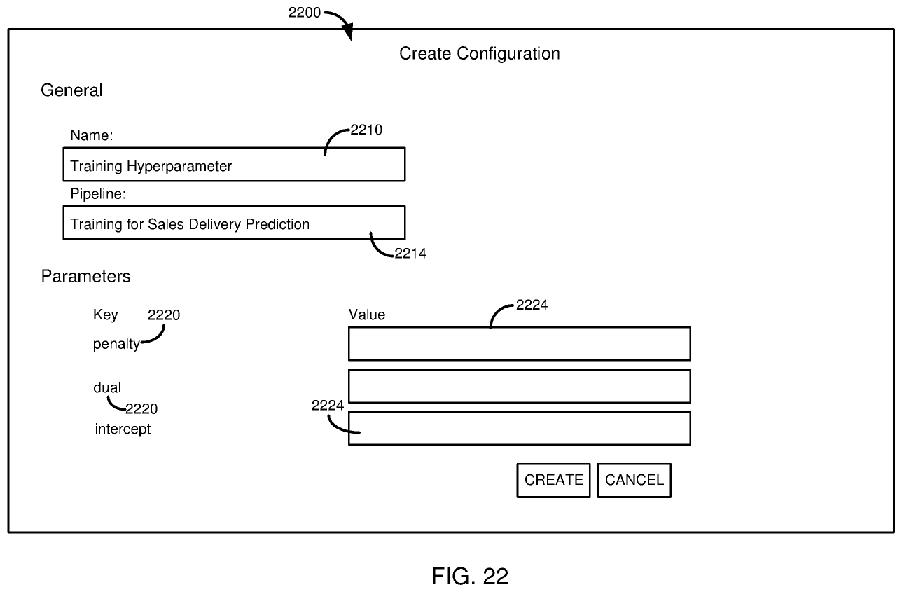

FIG. 22 provides an example user interface screen 2200 through which a user can define hyperparameters to be used with a machine learning model. Depending on the machine learning algorithm, the hyperparameters can be used during one or both of training a machine learning model and in using a model as part of responding to a request for a machine learning result.

The user interface screen 2200 includes a field 2210 where a user can enter a name for the hyperparameter settings, and a field 2214 where a user can enter a pipeline where the hyperparameter settings will be used. In some cases, a pipeline can represent a specific machine learning scenario. In other cases, a pipeline can represent one or more operations that can be specified for one or more machine learning scenarios. For example, a given pipeline might be specified for two different machine learning scenarios which use the same machine learning algorithm (or which have at least some aspects in common such that the same pipeline is applicable to both machine learning scenarios).

For each hyperparameter available for configuration, the user interface screen can provide a key identifier 2220 that identifies the particular hyperparameter and a field 2224 where a user can enter a corresponding value for the key. The keys and values can then be stored, such as in association with an identifier for the pipeline indicated in the field 2214. In at least some cases, the hyperparameters available for configuration can be defined for particular machine learning algorithms Typically, while a key user may select values for hyperparameters, a developer of a machine learning platform defines what hyperparameters will be made available for configuration.

### Example 16—Example Machine Learning Pipeline

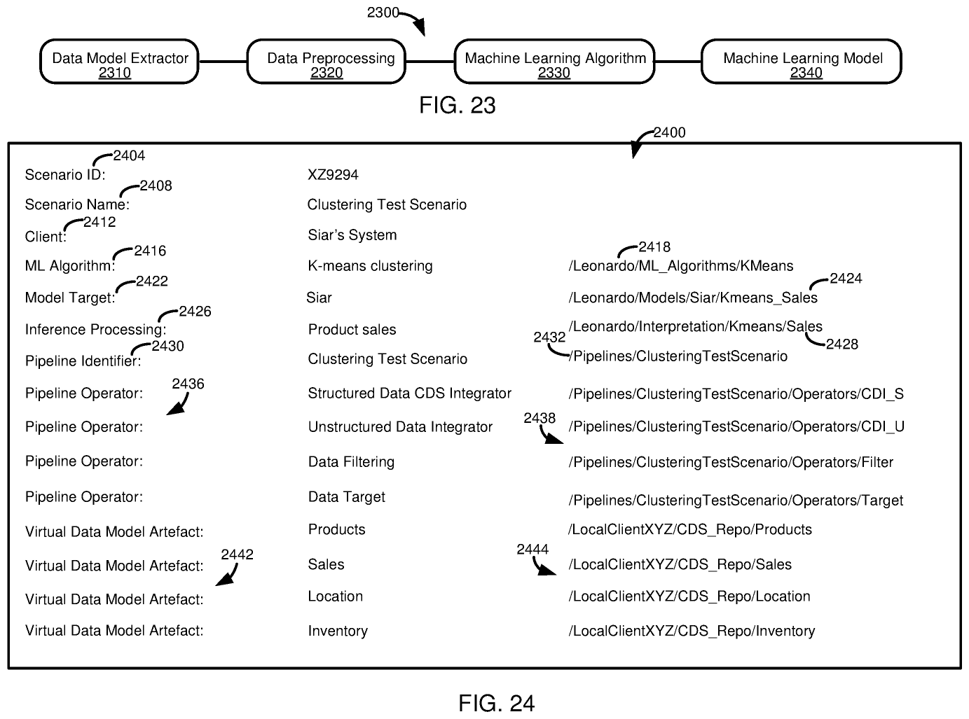

FIG. 23 illustrates an example of operators in a machine learning pipeline 2300 for a machine learning scenario. The machine learning scenario can represent a machine learning scenario of the type configurable using the user interface screens shown in FIGS. 17-22, or a scenario 1300, 1400 depicted in FIGS. 13 and 14.

The machine learning pipeline 2300 includes a data model extractor operator 2310. The data model extractor operator 2310 can specify artefacts in a virtual data model from which data can be extracted. The data model extractor operator 2310 typically will include path/location information useable to locate the relevant artefacts, such as an identifier for a system on which the virtual data model is located, an identifier for the virtual data model, and identifiers for the relevant artefacts.

The data model extractor operator 2310 can also specify whether data updates are desired and, if so, why type of change data processing should be used, such as whether timestamp/date based change detection should be used (and a particular attribute to be monitored) or whether change data capture should be used, and how often updates are requested. The data model extractor operator 2310 can specify additional parameters, such as a package size that should be used in transferring data to the cloud system (or, more generally, the system to which data is being transferred).

In other cases, the data model extractor operator 2310 can specify unstructured data to be retrieved, including options similar to those used for structured data. For example, the data model extractor operator 2310 can specify particular locations for unstructured data to be transferred, particular file types or metadata properties of unstructured data that is requested, a package size for transfer, and a schedule at which to receive updated data or to otherwise refresh the relevant data (e.g., transferring all of the requested data, rather that specifically identifying changed unstructured data).

Typically, the type of data model extractor operator 2310 is selected based on the nature of a particular machine learning scenario, including the particular algorithm being used. In many cases, machine learning algorithms are configured to use either structured data or unstructured data, at least for a given scenario. However, a given machine learning extraction pipeline can include a data model extractor operator 2310 that requests both structured and unstructured data, or can include multiple data model extractor operators (e.g., an operator for structured data and another operator for unstructured data).

The machine learning pipeline 2300 can further include one or more data preprocessing operators 2320. A data preprocessing operator 2320 can be used to prepare data for use by a machine learning algorithm operator 2330. The data preprocessing operator 2320 can perform actions such as formatting data, labelling data, checking data integrity or suitability (e.g., a minimum number of data points), calculating additional values, or determining parameters to be used with the machine learning algorithm operator 2330.

The machine learning algorithm operator 2330 is a particular machine learning algorithm that is used to process data received and processed in the machine learning pipeline 2300. The machine learning algorithm operator 2330 can include configuration information for particular parameters to be used for a particular scenario of interest, and can include configuration information for particular output that is desired (including data visualization information or other information used to interpret machine learning results).

The machine learning pipeline 2300 includes a machine learning model operator 2340 that represents the machine learning model produced by training the machine learning algorithm associated with the machine learning algorithm operator 2330. The machine learning model operator 2340 represents the actual model that can be used to provide machine learning results.

Typically, once the machine learning pipeline 2300 has been executed such that the operators 2310, 2320, 2330 have completed, a user can call the machine learning model operator 2340 to obtain results for a particular scenario (e.g., a set of input data). Unless it is desired to update or retrain the corresponding algorithm, it is not necessary to execute other operators in the machine learning pipeline 2300, particularly operations associated with the data model extractor operator 2310.

### Example 17—Example Machine Learning Scenario Definition

FIG. 24 illustrates example metadata 2400 that can be stored as part of a machine learning scenario. The machine learning scenario can represent a machine learning scenario of the type configurable using the user interface screens shown in FIGS. 17-22, or a scenario 1300, 1400 depicted in FIGS. 13 and 14. Information in a machine learning scenario can be used to execute various aspects of the scenario, such as training a machine learning model (including a model segment) or using the model to process a particular set of input data.

The metadata 2400 can include a scenario ID 2404 useable to uniquely identify a scenario. A more semantically meaningful name 2408 can be associated with a given scenario ID 2404, although the name 2408 may not be constrained to be unique. In some cases, the scenario ID 2404 can be used as the identifier for a particular subscriber to structured or unstructured data. A particular client (e.g., system or end user) 2412 can be included in the metadata 2400.

An identifier 2416 can indicate a particular machine learning algorithm to be used for a given scenario, and can include a location 2418 for where the algorithm can be accessed. A target identifier 2422 can be used to indicate a location 2424 where a trained model should be stored. When the trained model is to be used, results are typically processed to provide particular information (including as part of a visualization) to an end user. Information useable to process results of using a machine learning algorithm for a particular set of input can be specified in a metadata element 2426, including a location 2428.

As discussed in prior Examples, a machine learning scenario can be associated with a particular machine learning pipeline, such as the machine learning pipeline 2300 of FIG. 23. An identifier of the pipeline can be specified by a metadata element 2430, and a location for the pipeline (e.g., a definition of the pipeline) can be specified by a metadata element 2432. Optionally, particular operators in the given machine learning pipeline can be specified by metadata elements 2436, with locations of the operators provided by metadata elements 2438.

In a similar manner, the metadata 2400 can include elements 2442 that specify particular virtual data model artefacts that are included in the machine learning scenario, and elements 2444 that specify a location for the respective virtual data model artefact. In other cases, the metadata 2400 does not include the elements 2442, 2444, and virtual data model artefacts can be obtained using, for example, a definition for a pipeline operator. While not shown, the metadata 2400 could include information for unstructured data used by the machine learning scenario, or such information could be stored in a definition for a pipeline operator associated with unstructured data.

### Example 18—Example Use of Features for Training and Use of Machine Learning Models

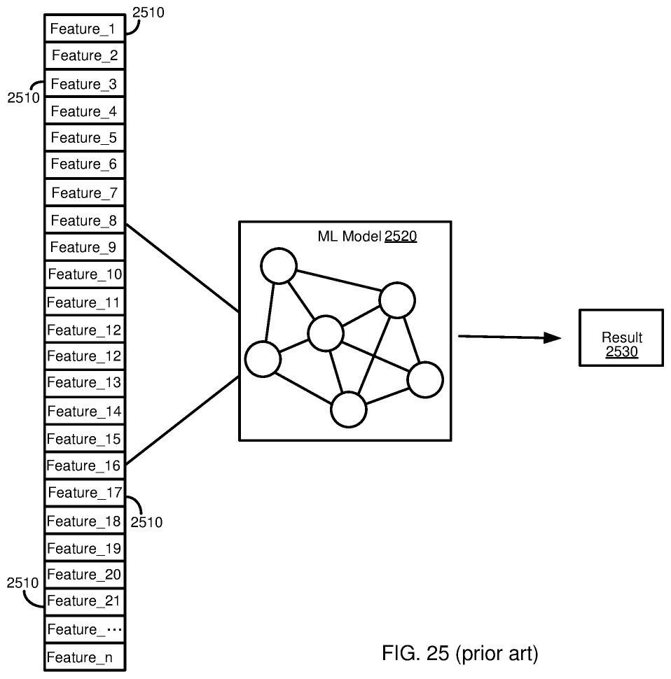

FIG. 25 schematically depicts how a plurality of features 2510 can be used as input to a machine learning model 2520 to provide a result 2530. Typically, the types of features 2510 used as input to provide the result 2530 are those used to train a machine learning algorithm to provide the machine learning model 2520. Training and classification can use discrete input instances of the features 2510, where each input instance has values for at least a portion of the features. Typically, the features 2510, and their respective values, are provided in a way that uses a particular feature in a particular way. For example, each feature 2510 may be mapped to a variable that is used in the machine learning model.

The result 2530 maybe be a qualitative or quantitative value, such as a numeric value indicating a likelihood that a certain condition will hold or a numeric value indicting a relative strength of an outcome (e.g., with high number indicating stronger/more valuable outcomes). For qualitative results, the result 2530 might be, for example, a label applied based on the input features 2510 for a particular input instance.

Note that for any of these results, typically the result 2530 itself does not provide information about how the result was determined. Specifically, the result 2530 does not indicate how much any given feature 2510 or collection of features contributed to the result. However, in many cases, one or more features 2510 will contribute positively towards the result, and one or more features may argue against the result 2530, and instead may contribute to another result which was not selected by the machine learning model 2520.

Thus, for many machine learning applications, a user may be unaware of how a given result 2530 relates to the input features for a particular use of the machine learning model. As described in Example 1, if users are unsure what features 2510 contributed to a result 2530, or to how or to what degree they contribute, they may have less confidence in the result. In addition, users may not know how to alter any given feature 2510 in order to try and obtain a different result 2530.

In at least some cases, it is possible to determine (for an individual classification results as an average or other statistical measure of a machine learning model 2520 over a number of input instances) how features 2510 contribute to results for a machine learning model. In particular, Lundberg, et al., “Consistent Individualized Feature Attribution for Tree Ensembles” (available at https://arxiv.org/abs/1802.03888, and incorporated by reference herein) describes how SHAP (Shapley additive explanation) values can be calculated for attributes used in a machine learning model, allowing the relative contribution of features 2510 to be determined. However, other contextual interpretability measures (which can also be termed contextual contribution values) may be used, such as those calculated using the LIME (local interpretable model-agnostic explanations) technique, described in Ribeiro, et al., “‘Why Should I Trust You?’ Explaining the Predictions of Any Classifier,” available at https://arxiv.org/pdf/1602.04938.pdf, and incorporated by reference herein. In general, a contextual contribution value is a value that considers the contribution of a feature to a machine learning result in the context of other features used in generating the result, as opposed to, for example, simply considering in isolation the effect of a single feature on a result.

Contextual SHAP values can be calculated as described in Lundberg, et al., using as using the equation:

$${ϕ}_{i} = {\sum }_{S ⊆ N \{ i \}} \frac{\vert S \vert ! ( M - \vert S \vert - 1 ) !}{M !} [ {f}_{x} ( S ⋃ \{ i \} ) - {f}_{x} ( S ) ]$$

as defined and used in Lundberg, et al.

A single-variable (or overall) SHAP contribution (the influence of the feature on the result, not considering the feature in context with other features used in the model), ϕ₁, can be calculated as:

$${ψ}_{X} = {ϕ}_{1} = logit ( \hat{P} ( Y \text{\textbar} X ) ) - logit ( \hat{P} ( Y ) )$$

$$Where \text{:}$$

$$logit ( \hat{P} ( Y \text{\textbar} X ) ) = logit ( \hat{P} ( Y ) ) + {\sum }_{i = 1}^{1} {ϕ}_{i}$$

$$And$$

$$logit ( p ) = log \frac{p}{1 - p}$$

The above value can be converted to a probability scale using:

\hat{P}(Y|X)=s(ψ_{X}+log it(\hat{P}(Y)))

Where s is the sigmoid function:

$$s ( x ) = \frac{1}{1 + {e}^{- x}}$$

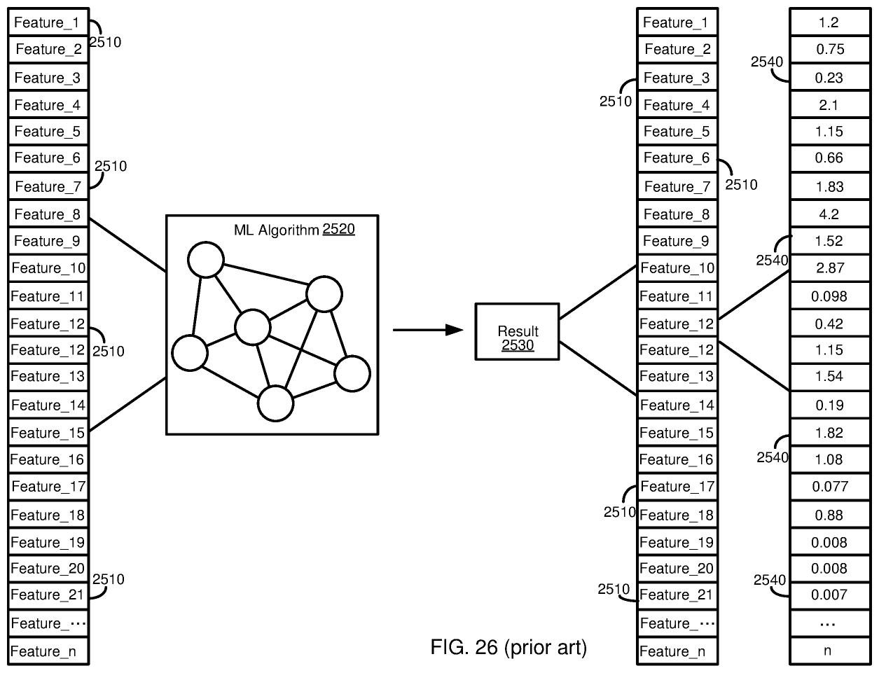

FIG. 26 is generally similar to FIG. 25, but illustrates how contribution values 2540 (such as those calculated using the SHAP methodology) can be calculated for features 2510. As explained in Example 1, a large number of features 2510 are used with many machine learning models. Particularly if the contribution value 2540 of each (or most or many) or the features 2510 is comparatively small, it can be difficult for a user to understand how any feature contributes to results provided by a machine learning model, including for a particular result 2530 of a particular set of values for the features 2510.

Similarly, it can be difficult for a user to understand how different combinations of features 2510 may work together to influence results of the machine learning model 2520.

In some cases, machine learning models can be simpler, such that post-hoc analyses like calculating SHAP or LIME values may not be necessary. For example, at least some regression (e.g., linear regression) models can provide a function that provides a result, and in at least some cases a relatively small number of factors or variables can determine (or at least primarily determine) a result. That is, in some cases, a regression model may have a larger number of features, but a relatively small subset of those feature may contribute most to a prediction (e.g., in a model that has ten features, it may be that three features determine 95% of a result, which may be sufficient for explanatory purposes such that information regarding the remaining seven features need not be provided to a user).

As an example, a linear regression model for claim complexity may be expressed as:

Claim Complexity−0.47+10⁻⁶ Capital+0.03 Loan Seniority−0.01 Interest Rate

Using values of 100,000 for Capital, 7 for Loan Seniority, and 3% for Interest Rate provides a Claim Complexity value of 0.75. In this case, global explanation information can include factors such as the overall predictive power and confidence of the model, as well as the variable coefficients for the model (as such coefficients are invariant over a set of analyses). The local explanation can be, or relate to, values calculated using the coefficients and values for a given analysis. In the case above, the local explanation can include that Capital contributed 0.1 to the result, Loan Seniority contributed 0.21, and Interest Rate contributed −0.03.

### Example 19—Example Interactions Between Features of Machine Learning Model

In some embodiments, explainable machine learning can include explanations of relationships between features. These relationships can be determined by various techniques, including using various statistical techniques. One technique involves determining mutual information for pairs of features, which identifies the dependence of the features on one another. However, other types of relationship information can be used to identify related features, as can various clustering techniques.

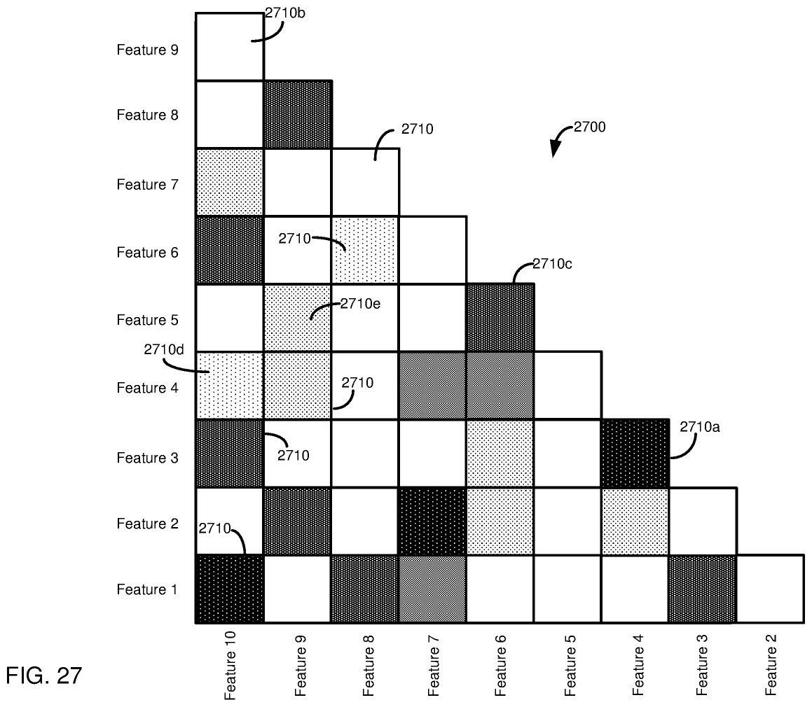

FIG. 27 illustrates a plot 2700 (e.g., a matrix) of mutual information for ten features. Each square 2710 represents the mutual information, or correlation or dependence, for a pair of different features. For example, square 2710a reflects the dependence between feature 3 and feature 4. The squares 2710 can be associated with discrete numerical values indicating any dependence between the variables, or the values can be binned, including to provide a heat map of dependencies.

As shown, the plot 2700 shows the squares 2710 with different fill patterns, where a fill pattern indicates a dependency strength between the pair of features. For example, greater dependencies can be indicated by darker fill values. Thus, square 2710a can indicate a strong correlation or dependency, square 2710b can indicate little or no dependency between the features, and squares 2710c, 2710d, 2710e can indicate intermediate levels of dependency.

Dependencies between features, at least within a given threshold, can be considered for presentation in explanation information (at least at a particular level of explanation granularity). With reference to the plot 2700, it can be seen that feature 10 has dependencies, to varying degrees, on features 1, 3, 4, 6, 7. Thus, a user interface display could provide an indication that feature 10 is dependent on features 1, 3, 4, 6, and 7. Or, feature 4 could be excluded from the explanation, if a threshold was set such that feature 4 did not satisfy the interrelationship threshold. In other embodiments, features having at least a threshold dependence on features 3, 4, 5, 6, 7 could be added to explanation information regarding dependencies of feature 10.

Various criteria can be defined for present dependency information in explanation information, such as a minimum or maximum number of features that are dependent on a given feature. Similarly, thresholds can be set for features that are considered for possible inclusion in an explanation (where features that do not satisfy the threshold for any other feature can be omitted from the plot 2700, for example).

Various methods of determining correlation can be used, such as mutual information. Generally, mutual information can be defined as I(X; Y)=D_{KL}(P_{X,Y)}∥P_{X}⊗P_{Y}), where X and Y are random variables having a joint distribution P_{(X,Y)} and marginal distributions of P_{X} and P_{Y}. Mutual information can include variations such as metric-based mutual information, conditional mutual information, multivariate mutual information, directed information, normalized mutual information, weighted mutual information, adjusted mutual information, absolute mutual information, and linear correlation. Mutual information can include calculating a Pearson's correlation, including using Pearson's chi-squared test, or using G-test statistics.

When used to evaluate a first feature with respect to a specified (target) second feature, supervised correlation can be used: scorr(X, Y)=corr(ψ_{X},ψ_{Y}), where scorr is Pearson's correlation and ψ_{X}=log it(\hat{P}(Y|X))−log it(\hat{P}(Y)) (binary classification).

In some examples, dependence between two features can be calculated using a modified X² test:

$$cell ( X = x , Y = y ) = \frac{( {O}_{xy} - {E}_{xy} ) \cdot \vert {O}_{xy} - {E}_{xy} \vert}{{E}_{xy}}$$

$$Where \text{:}$$

$${E}_{xy} = \frac{{\sum }_{i = 1}^{I} {O}_{iy} {\sum }_{j = 1}^{J} {O}_{xj}}{N}$$

O_{xy} is the observed count of observations of X=x and Y=y, while E_{xy} is the count that is expected if X and Y are independent.

Note that this test produces a signed value, where a positive value indicates that observed counts are higher than expected and a negative value indicates that observed counts are lower than expected.

In yet another implementation, interactions between features (which can be related to variability in SHAP values for a feature) can be calculated as:

$$logit ( \hat{P} ( Y \text{\textbar} {X}_{1} , {X}_{2} , … {X}_{n} ) ) = logit ( \hat{P} ( Y ) ) + {\sum }_{i , j} {ϕ}_{ij}$$

Where ϕᵢᵢ is the main SHAP contribution of feature i (excluding interactions) and ϕᵢⱼ+ϕⱼᵢ is the contribution of the interaction between variables i and j with ϕᵢⱼ≃ϕⱼᵢ. The strength of an interaction between features can be calculated as:

$${I}_{ij} = 2 \frac{\sum \vert {ϕ}_{ij} \vert + \vert {ϕ}_{ji} \vert}{\sum \vert {ϕ}_{ii} \vert + \sum \vert {ϕ}_{jj} \vert}$$

### Example 20—Example Display for Illustrating Relationships Between Features

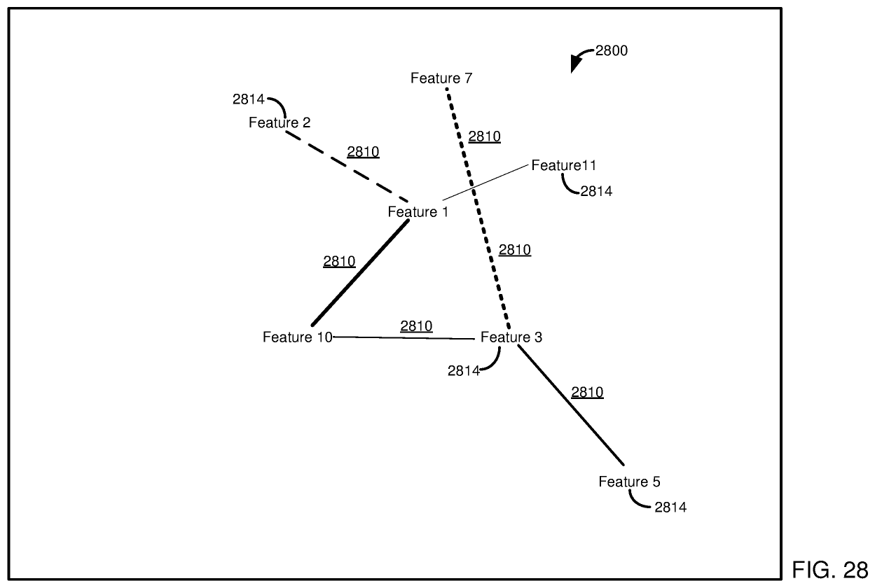

Mutual information, or other types of dependency or correlation information, such as determined using techniques described in Example 19, can be presented to a user in different formats. For example, FIG. 28 illustrates a plot 2800 showing relationships 2810 between features 2814, which can be features for which the strength of the relationship satisfied a threshold.

The relationships 2810 can be coded with information indicating the relative strength of the relationship. As shown, the relationships 2810 are shown with different line weights and patterns, where various combinations of pattern/weight can be associated with different strengths (e.g., ranges or bins of strengths). For instance, more highly dashed lines can indicate weaker relationships for a given line weight, and increasingly heavy line weights can indicate stronger relationships/dependencies. In other cases, the relationships 2810 can be displayed in different colors to indicate the strength of a relationships.

### Example 21—Example Progression Between User Interface Screens with Different Granularities of Machine Learning Explanation

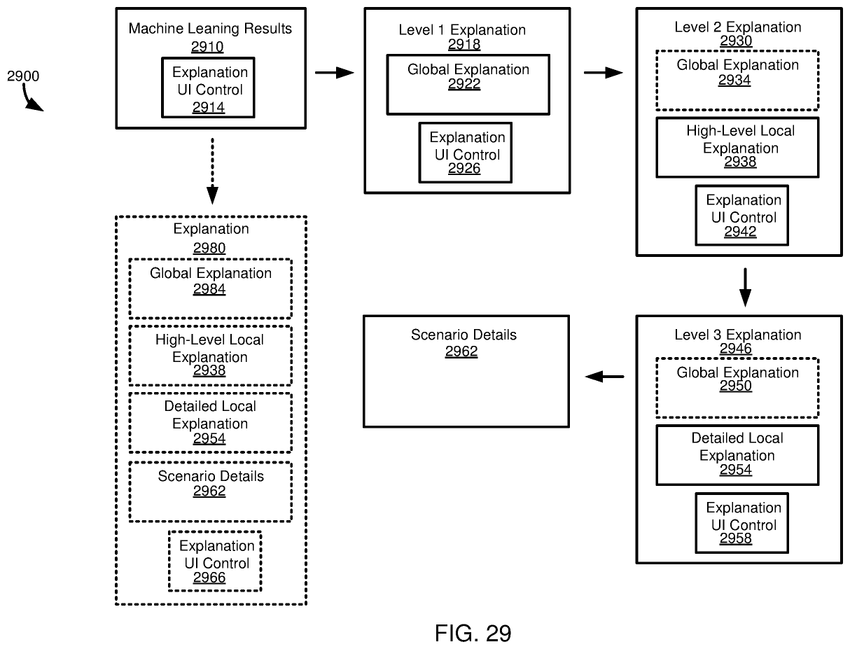

Machine learning explanations can be provided, including upon user request, at various levels of granularity. FIG. 29 illustrates a scenario 2900 where a user can selectively choose to receive machine learning explanations at various levels of granularity, or where a display concurrently displays explanation information at multiple levels of granularity.

In the scenario 2900, a user interface screen 2910 can represent a base display that provides results of one or more machine learning analyses without explanation information. By selecting an explanation user interface control 2914, the user can navigate to a user interface screen 2918 that provides a first level explanation of at least one of the machine learning analyses displayed on the user interface screen 2910.

The first level explanation of the user interface screen 2918 can provide a global explanation 2922. The global explanation 2922 can provide information regarding analysis provided by a machine learning algorithm, generally (e.g., not with respect to any particular analysis, but which may be calculated based at least in part on a plurality of analyses). The global explanation 2922 can include information such as the predictive power of a machine learning model, the confidence level of a machine learning model, contributions of individual features to results (generally), relationships (such as dependencies) between features, how results are filtered, sorted, or ranked, details regarding the model (e.g., the theoretical basis of the model, details regarding how the model was trained, such as a number of data points used to trained the model, information regarding when the model was put into use or last trained, how many analyses have been performed using the model, user ratings of the model, etc.), or combinations of these types of information.

In some cases, aspects of the global explanation 2922 can be determined by evaluating a data set for which the results are known. Comparing the results provided by the machine learning algorithm with the known, correct results can allow factors such as the predictive power and confidence of the model to be determined. Such comparison can also allow individual contributions of features toward a model result to be calculated (e.g., by taking the mean over observations in the training set), dependencies between features, etc.

Although, as will be further described, the scenario 2900 allows a user to obtain different levels of details regarding a local explanation, it should be appreciated that global explanation information can be handled in a similar manner That is, information such as the overall predictive power of a machine learning model and its confidence value can be presented at a high-level. A user can select a user interface control to obtain more granular global explanation information, such as regarding feature contributions/dependencies, if desired.

From the user interface screen 2918, by selecting a user interface control 2926, a user can navigate to a user interface screen 2930 to obtain a high-level local explanation 2938 of one or more machine learning analyses. Optionally, the user interface screen 2930 can include a global explanation 2934, which can be the same as the global explanation 2922 or can be different (for example, being more granular).

The high-level local explanation 2938 can include a high-level explanation of why a particular result was obtained from a machine learning model for one or more particular analyses. The information can include a score for an analysis, which can be supplemented with information regarding the meaning of a score. For example, if a score indicates a “good” result, the score can be highlighted in green or otherwise visually distinguished. Similarly, “average” results can be highlighted in yellow or orange, while “bad” results can be highlighted in red.

In some cases, a machine learning result, such as displayed on the user interface screen 2910, may be result a single result of multiple considered options, or otherwise may be a subset of all considered options. A result provided in the user interface screen 2918 can be the highest ranked/selected result, in some implementations. Thus, a user may be unaware of why the result was selected/any other options that may have been considered. The high-level local explanation 2938 can include information for additional (including all, or a subset of) options that were considered, and can list the scores for the results, optionally with color-coding, as described above, or otherwise provide information to indicate a qualitative category for the result (e.g., “good,” “bad,” “average”).

From the user interface screen 2930, by selecting a user interface control 2942, a user can navigate to a user interface screen 2946 to obtain a detailed local explanation 2954 of one or more machine learning analyses. Optionally, the user interface screen 2946 can include a global explanation 2950, which can be the same as the global explanation 2922 or can be different (for example, being more granular).

Compared with the high-level local explanation 2938, the detailed local explanation 2954 can include more granular details regarding one or more machine learning analyses. Where the high-level local explanation 2938 included an overall score for an analysis, the detailed local explanation 2954 can include values for individual features of the analysis, which can be values as input to the machine learning algorithm, values calculated from such input values, or a combination thereof. Considering the claim complexity model discussed in Example 18, values of input features can include the Capital value of 100,000, the Loan Seniority value of 7 years, or the Interest Rate of 3%. Values calculated from input features can include the 0.1 value for Capital obtained using the 100,000 input value, the 0.03 value for Loan Seniority obtained using the 7 years input value, or the −0.01 value for Interest Rate calculated using the 3% input value.

If desired, qualitative aspects of the input or calculated values can be indicated in an analogous manner as described for the high-level local explanation 2938. For instance, input or calculated features that are high (or favorable) can be highlighted in green, while low (or negative) features can be highlighted in red, and intermediate (or average) features can be highlighted in orange or yellow. Comparative information can also be provided, such as providing an average value for multiple analysis from which a result was selected or an average value for a set of analyses evaluated using the machine learning algorithm (which can be associated with a data set used to train the machine learning algorithm/determine the global explanation 2922).

In some cases, a user may wish to view information regarding a machine learning result, or from alternatives that were considered but not selected. An example discussed later in this disclosure relates to selection of a supplier for a particular item. A number of suppliers may be considered and scored based on various criteria, such as price, delivery time, and minimum order quantity. The machine learning result presented in the user interface screen 2910 can be the selected or recommend supplier. Information presented in the user interface screen 2930 for the high level local explanation 2950 can include the score for the selected supplier, and for alternative suppliers considered. Information presented in the user interface screen 2946 for the detailed local explanation 2954 can include input values for the different suppliers, such as the different delivery times, minimum quantities, and prices.

By selecting an explanation user interface control 2958, the user can be presented with a scenario details user interface screen 2962. The scenario details user interface screen 2962 can provide information regarding one or more results or considered options for a scenario (a set of one or more analyses).

In the supplier selection scenario, the scenario details user interface screen 2962 can present information regarding prior interactions with a supplier—which can include information related to features used by the machine learning model (e.g., actual delivery time) or features not used by the machine learning model but which may be of interest to a user (e.g., whether any problems were noted with the supplier, an item defect rate).

Although FIG. 29 illustrates a particular progression between the user interface screens 2910, 2918, 2930, 2946, 2962, other alternatives are possible. For example, a user may be provided with an option to view the scenario details user interface screen 2962 from one or more of the user interface screens 2910, 2918, 2930. Similarly, a user may be provided with an option to view the level 2 explanation screen 2930 or the level 3 explanation screen 2946 from the machine learning results user interface screen 2910. A user may be provided with an option to transition to the level 3 explanation user interface screen 2946 from the level 1 explanation user interface screen 2918.

In a similar manner, aspects of the different displays 2910, 2918, 2930, 2946, 2962 can be reconfigured as desired. For example, an explanation user interface screen 2980 includes one or more of a global explanation 2984 (which can be analogous to the global explanation 2922 or the global explanation 2934), the high-level local explanation 2938, the detailed local explanation 2954, or the scenario details 2962. An explanation user interface control 2966 (or multiple controls) can allow a user to selectively display various information elements included in the explanation user interface screen 2980.

### Example 22—Example User Interface Screens for Displaying Machine Learning Explanation Information

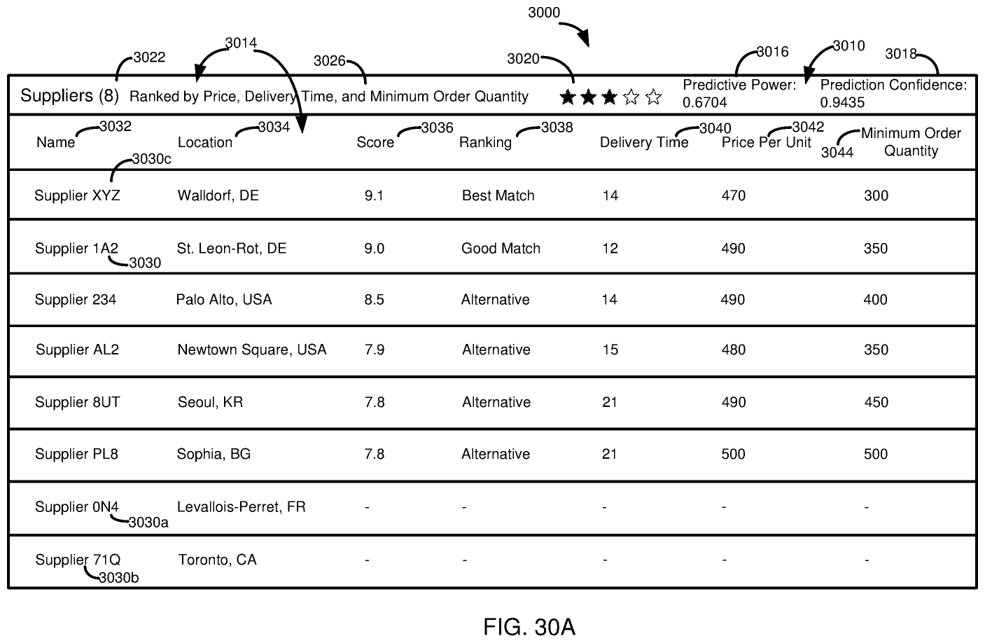

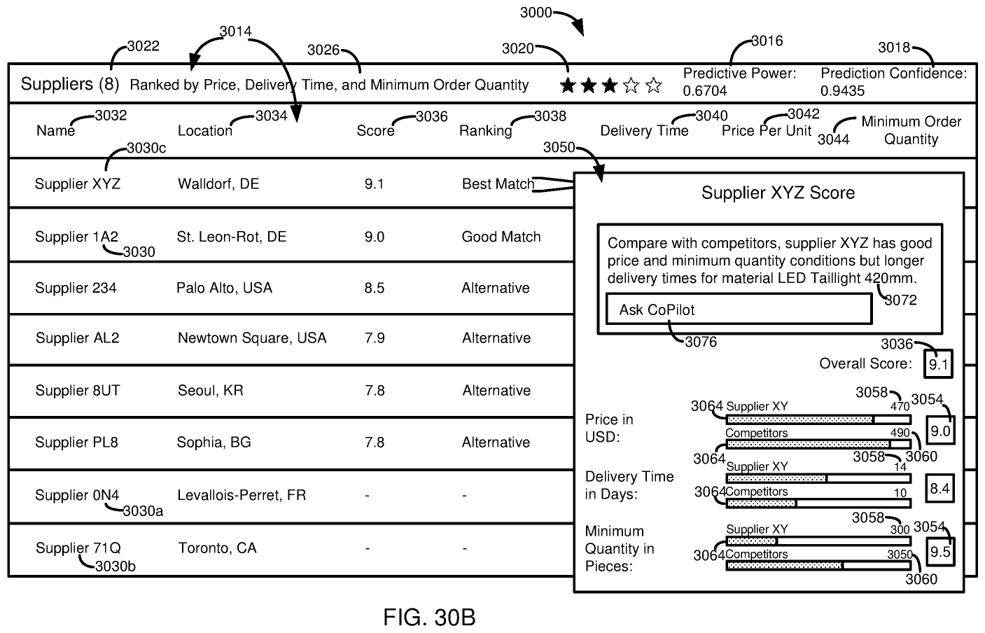

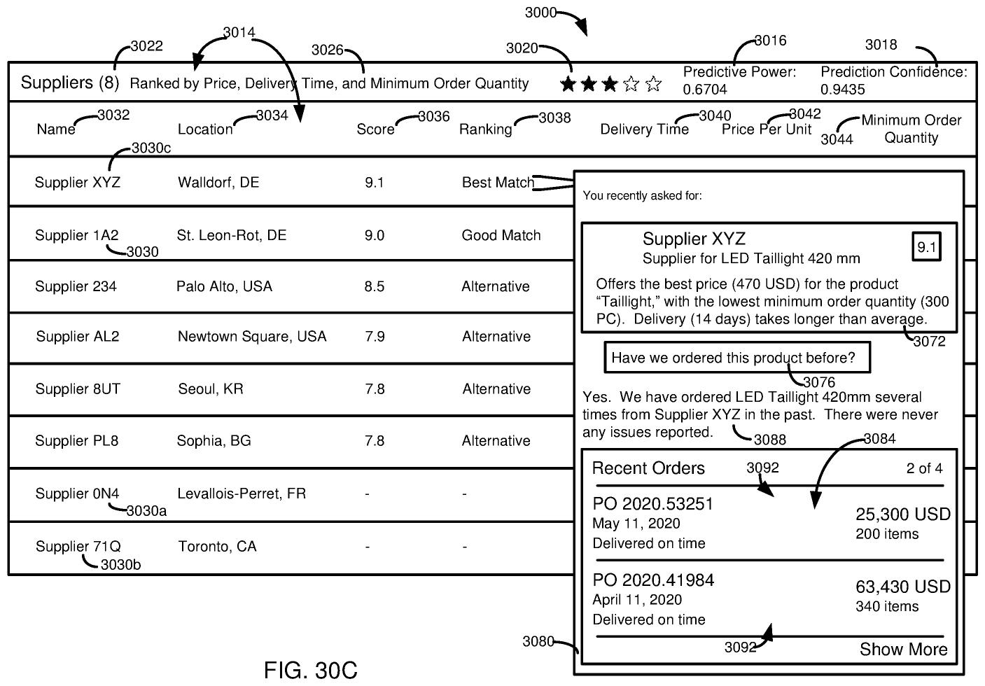

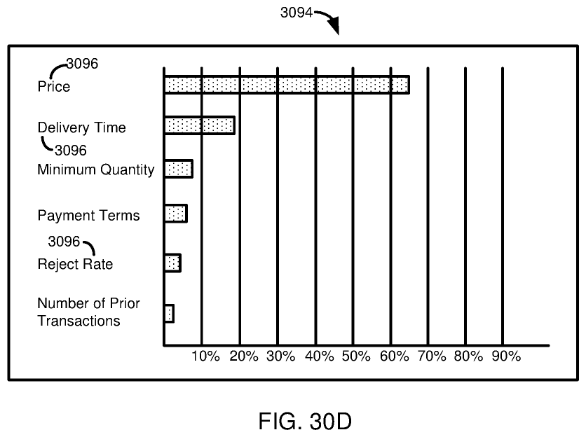

FIGS. 30A-30D illustrate embodiment of an example user interface screen 3000 that provides explanation information for a machine learning model to a user. The user interface screen 3000 can implement some or all of the user interface screens 2910, 2918, 2930, 2946, 2962, 2980 of FIG. 29. Text in FIGS. 30A-30D reflects the scenario discussed in Example 21, relating to a machine learning model that selects or recommends a supplier for the order of a particular part.

FIG. 30A illustrates the user interface screen 3000 providing global explanation information 3010 and local explanation information 3014. As shown in FIG. 30A, the user interface screen 3000 can at least generally correspond to the level 2 explanation user interface screen 2930 of FIG. 29.

The global explanation information 3010 includes a display 3016 of the predictive power of the machine learning model and a display 3018 of the prediction confidence of the machine learning model. This information can give a user a general sense of how useful the results of the machine learning model might be. An indicator 3020 can reflect user-feedback regarding the usefulness of the machine learning model—as shown providing a star rating (e.g., a larger number of stars indicating increased user confidence or perceived value of the machine learning model). Ranking/scoring criteria 3026 is provided in the user interface screen 3000, which indicates how results 3030 for individual suppliers are listed on the screen. As shown, the ranking is based on consideration of input features of price, delivery time, and minimum order quantity.

The local explanation information 3014 can include a variety of aspects. The user interface screen 3000 can display a number of options 3022 considered. As shown, the user interface screen 3000 indicates that eight suppliers were considered in generating a result, such as a recommended supplier.

The list of results 3030 includes, for six of the eight suppliers considered in the example scenario, the name 3032 of the supplier, the location 3034 of the supplier, the score 3036 assigned to the supplier, a qualitative indicator 3038 that assigns a label to the supplier (e.g., “best,” “good,” “alternative,” as shown), the delivery time 3040 of the supplier, the price per unit 3042 of the part from the supplier, and the minimum order quantity 3044 required by the supplier associated with a given result 3030. Note that values are not supplied for the score 3036, qualitative label 3038, delivery time 3040, price per unit 3042, or minimum order quantity for suppliers associated with results 3030a, 3030b. This can be, for example, because information needed to analyze the suppliers associated with results 3030 using the machine learning model was not available, or because the suppliers otherwise did not meet threshold criteria (e.g., the part is not available from those two suppliers, even though a company might obtain other parts from those suppliers).

It can be seen that both the global explanation information 3010 and the local explanation information 3014 can assist a user in understanding a result provided by a machine learning model. If the user was only presented with the result, such as an indicator identifying supplier 3030c as the selected result, the user may not have any idea of the basis for such a selection, and so may question whether the result is reasonable, accurate, or should be followed. The global explanation information 3010 provides a user with a general understanding of how useful predictions provided by the machine learning model may be. The local explanation information 3014 allows a user to even better understand how a result for a particular scenario was determined. The user knows that other alternatives were considered, what their scores were, and the input values used to determine the score. So, the user can see that supplier 3030c indeed had the highest score, and can infer that the selection was based on the supplier having the best overall combination of input values for the suppliers 3030 considered.

In FIG. 30A, a user may be able to select a result 3030 (e.g., such as by selecting the score 3036 or qualitative indicator 3038) to view more granular local explanation information 3050, such as for that particular result, as shown in FIG. 30B. The user interface screen 3000 as shown in FIG. 30B can correspond to the level 3 user interface screen 3030 of FIG. 30A.

The granular local explanation information 3050 includes the score 3036, which can be highlighted or otherwise visually differentiated to indicate a qualitative aspect of the score (e.g., corresponding to the qualitative indicator 3038). The granular local explanation information 3050 includes score component information 3054. The score component information 3054 breaks down the overall score 3036 into scores for individual features that contribute to the overall score.

For each aspect of the component information 3054, information can be provided that compares component information of the selected supplier 3030 with information for other suppliers that were considered (which can be, for example, an average value from suppliers considered other than the selected supplier, or of all considered suppliers, including the selected supplier). The information can input the input value 3058 for the selected supplier and the input value 3060 for the other suppliers. Bar graphs 3064 or other visual indicators can be used to help a user visualize the relative significance of the input values 3058, 3060.

The granular local explanation information 3050 can include a textual description 3072 of a rationale regarding why the selected supplier 3030 was or was not selected as the result of the machine learning model. The textual description 3072 can be automatically produced using application logic, such by using various templates and keywords associated with particular values or relationships (e.g., using “lower” when one score is lower than another score).

The textual description 3072, as shown, explains how the component information 3054 for a selected supplier compared with component information for other suppliers. When the supplier 3030 for which additional detail is being provided is not the selected supplier 3030c, the component information 3050 and the textual description 3072 can compare the values for the supplier to the selected supplier in addition to, or rather than, providing the average value as the comparison.

An input field 3076 can be provided that allows a user to obtain more information regarding a selected supplier 3030, such as historical records associated with the supplier. The input field 3076 can correspond to the user interface control 3058 of FIG. 30B that allows a user to view the scenario details user interface screen 3062.

It can be seen how the granular local explanation information 3050 provides additional local explanation information 3014 beyond that provided in the user interface screen 3000 of FIG. 30B. The component information 3054 allows a user to see how individual features contributed to an overall result. Providing the input values 3058, as well as the bar graphs 3064 and the textual description 3072, assists a user in understanding why the supplier 3030c was chosen as opposed to other suppliers. For example, by looking at the granular local explanation information 3050, the user can appreciate that the supplier associated with the result 3030c was chosen at least in part because of its comparatively low price and minimum order quantity, even though the delivery time was longer than other suppliers.

Thus, the granular local explanation information 3050 can help a user determine whether selection of the supplier 3030c was an appropriate decision or conclusion. In some cases, for example, a user may decide that delivery time is more important than as applied by the machine learning model, and so may choose to select a different supplier with a shorter delivery time, even though the price or minimum order quantity may not be as favorable as the supplier 3030c. Viewing granular local explanation information 3050 for other suppliers 3030, such as suppliers still having a comparatively high scores 3036, can assist a user in evaluating other suppliers that might be appropriate for a given purchase.

FIG. 30C illustrates the user interface screen 3000 after a user has entered a query in the input field 3076. In some cases, input provided in the input field 3076 can be used to generate a query in a query language (e.g., SQL), including using natural language processing techniques. Suitable software for processing input provided in the input field 3076 includes technologies associated with Fiori CoPilot, available from SAP SE, of Walldorf, Germany. Data used to form a query can include data associated with a selected supplier, including data used in generating the result 3030c. For example, a name or other identifier of a selected supplier, as well as a part number, can be used as part of a formulated query.

In response to input provided in the input field 3076 and query execution, a panel 3080 of the user interface screen 3000 (which can previously have displayed the granular local explanation information 3050) can display scenario details 3084, which can correspond to information provided in the scenario details user interface screen 2962 of FIG. 29.

The panel 3080 can include a result explanation 3088, in the form of natural language text, as well as results data 3092. The results explanation 3088 can provide a high level summary of the results. For example, as shown, a user has asked if a particular part was previously obtained from a selected supplier 3030. The results explanation 3088 provides a yes/no answer, whereas the results data 3092 can provide details regarding specific prior interactions with the supplier, which can be based at least in part on database records accessed through a query generated using input provided in the input field 3076 and data associated with the selected supplier in the user interface screen 3000, including the granular local explanation 3050, or the local explanation information 3014, generally.

However, the results explanation 3088 can be configured to provide additional information that may be of interest to a user. As shown, the results explanation 3088 indicates whether any issues were previously experienced with the supplier, generally. Such information can be helpful, such as if a number of results are included in the results data 3092. Otherwise, such information might be overlooked by a user, including if the user did not review all of the results data 3092.

FIG. 30D presents a graph 3094 that can be displayed on the user interface screen 3000, such as in association with the granular local explanation information 3050. The graph 3094 illustrates contributions of individual features 3096 to an overall result, which can help a user assess why a particular supplier 3030 was or was not selected as a result, or why a particular score 3036 was obtained for a particular supplier.

### Example 23—Example Process for Generating Machine Learning Explanations

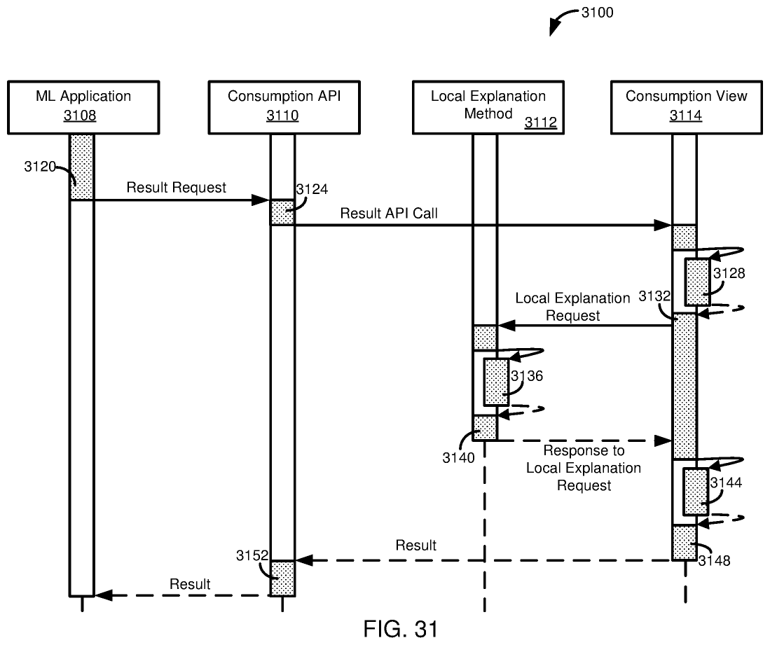

FIG. 31 is a timing diagram 3100 that provides an example of how an application 3108 that provides machine learning results can obtain a local explanation. The timing diagram 3100 can represent a process useable to generate various user interface screens of FIG. 29, or one or more permutations of the user interface screen 3000 of FIGS. 30A-30D.

The timing diagram 3100 illustrates interactions between the application 3108, a consumption API 3110, a consumption view 3114, and a local explanation method 3112. The consumption API 3110 and the consumption view 3114 can be views based on data obtained from a database. In particular examples, the consumption API 3110 and the consumption view 3114 can be implemented as in technologies provided by SAP SE, of Walldorf, Germany, including using SAP's Core Data Services, including Core Data Services Views.

At 3120, the application 3108 sends a request for a prediction using a machine algorithm to the consumption API 3110. The request can be generated automatically in response to processing by the application 3108 to generate a user interface screen, or can be called in response to specific user action (e.g., selection of a user interface control).

The request is received by the consumption API 3110. In response, at 3124, the consumption API 3110 calls functionality of the consumption view 3114 to generate a result, or prediction, using a machine learning model. The consumption view 3114 can generate the result at 3128. Generating the result at 3128 can include accessing other views (e.g., composite views or basic views), as well as calling a machine learning algorithm (such as in a function library), including calling the machine learning algorithm using data obtained from the other views.

At 3132, the consumption view 3114 can issue an explanation request to the local explanation method 3112. The explanation request can include all or a portion of the result generated at 3128 or data used in generating the result. At 3136, the local explanation method 3112 generates a local explanation for data received in the request generated at 3128. The local explanation can include information as described in Examples 1, 5, or 6. The local explanation can be stored at 3136, and a response can be sent to the consumption view 3114 at 3140. In some cases, the response includes all or a portion of the local explanation generated at 3136. In other cases, the response can be an indication that the local explanation was successfully generated, and optionally an identifier useable to access such local explanation.

Optionally, at 3144, the consumption view 3114 can read a global explanation for the machine learning model. At 3148, the machine learning result is returned to the consumption API 3110 by the consumption view 3114. At 3152, the machine learning result is returned to the application 3108 by the consumption API 3110. In some cases, the communications at 3148, 3152 can include additional information, such as all or a portion of a global explanation or a local explanation, or information useable to access one or both of the explanations. That is, in some cases the response generated at 3152 for the request issued at 3120 includes the machine learning result and explanation information. The application 3108 can automatically display the explanation information, or maintain the explanation information in the event a user later requests such information. In other cases, the response at 3152 does not include, or at least does not include all of, the explanation information. In such cases, the application 3110 can later issue a request for the explanation information (including by making a suitable request to the consumption API 3110) or can otherwise access the explanation information (e.g., by using identifiers sent at 3152).

It should be appreciated the operations shown in the timing diagram 3100 can be carried out in a different order than shown. For example, after receiving the request 3120, the consumption API 3110 can call the local explanation method 3112 to generate the local explanation, at least when the local explanation does not depend on the machine learning result. A status of the request to generate the local explanation can be returned to the consumption API 3110, which can then carry out the remainder of the operations shown in FIG. 31 (i.e., determining a machine learning result, reading local and global explanation information, and returning results to the application 3108).

### Example 24—First Example Architecture for Providing Machine Learning Explanations

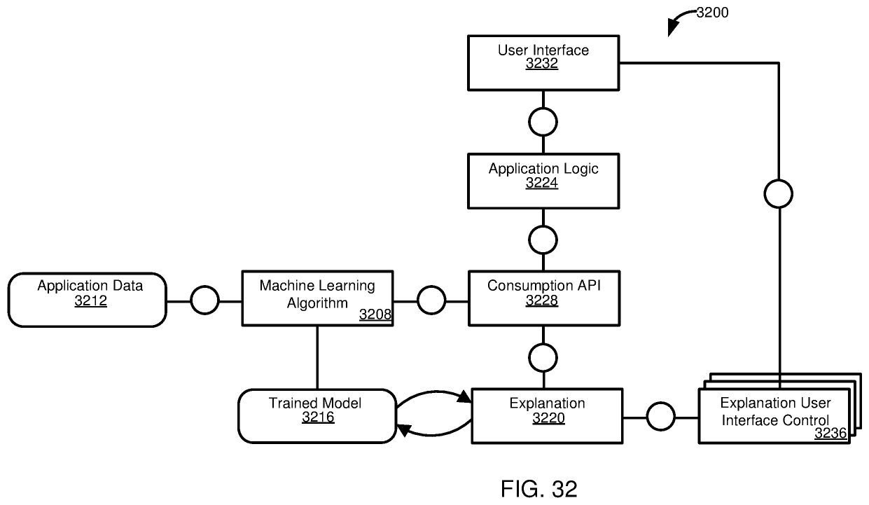

FIG. 32 illustrates an example architecture 3200 in which disclosed technologies can be implemented. A machine learning algorithm 3208 can receive application data 3212, such as through an interface provided by the machine learning algorithm. The machine learning algorithm 3208 can access a trained model 3216, which can be accessed by an explanation component 3220 to receive, or determine, a global explanation, or to generate analysis results.

Application logic 3224 can access a consumption API 3228, which can cause the machine learning algorithm 3208 to receive the application data 3212 and calculate a result using the trained model 3216. In turn, the consumption API 3228 can access the explanation component 3220 to obtain one or both of a local explanation or a global explanation. Interactions between the consumption API 3228 and the explanation component 3220 can be at least analogous to the process described with respect to FIG. 31, where the application 3208 can be associated with the application data 3212, the application logic 3224, and a user interface 3232 that includes one or more explanation user interface controls 3236 (e.g., for obtaining different types of explanations, such as global or local, or obtaining explanations at different levels of granularity).

### Example 25—Second Example Architecture for Providing Machine Learning Explanations

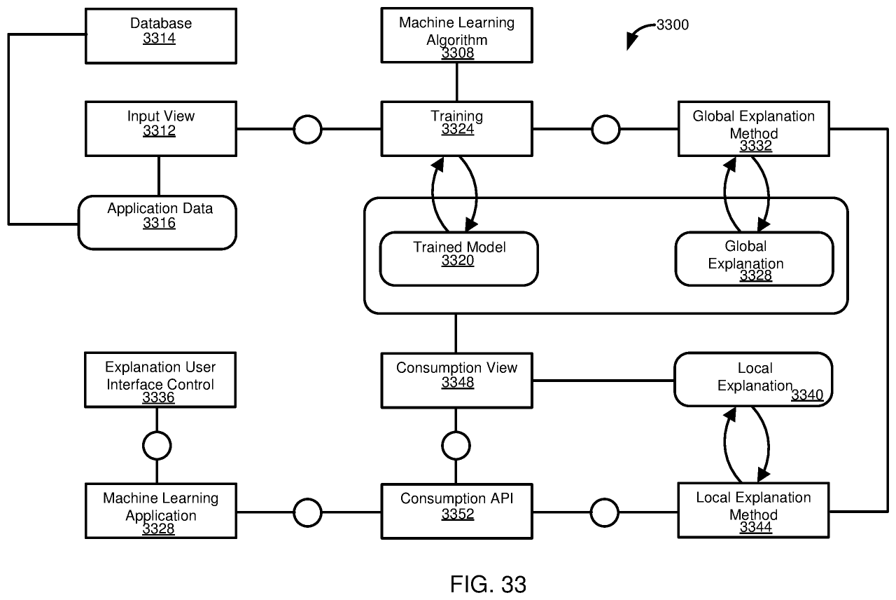

FIG. 33 illustrates an example architecture 3300 in which disclosed technologies can be implemented. A machine learning algorithm 3308 can access an input view 3312 (e.g., data obtained from a database system 3314, such as a core data services view) that can be generated from application data 3316. The machine learning algorithm 3308 can use the application data 3316 to generate a trained machine learning model 3320 (using a training component 3324) or in generating a machine learning result for a particular analysis/observation requested by a machine learning application 3328 (an application that provides machine learning results obtained using the machine learning algorithm 3308).

A global explanation method 3332 can access the training component 3324 to generate a global explanation 3328. For example, the training component 3324 can access application data 3316 for which a result is known, calculate results using the machine learning model 3308, and generate the global explanation 3328 by comparing the calculated results with the actual results.

A user can select an explanation user interface control 3336 of the machine learning application 3328 to request an explanation, which can be one or both of the global explanation 3328 or a local explanation 3340. The local explanation 3340 can be generated from a local explanation method 3344 that can access the application data 3316 through a consumption view 3348 which can be accessed using a consumption API 3352.

### Example 26—Example Relationship Between Elements of a Database Schema

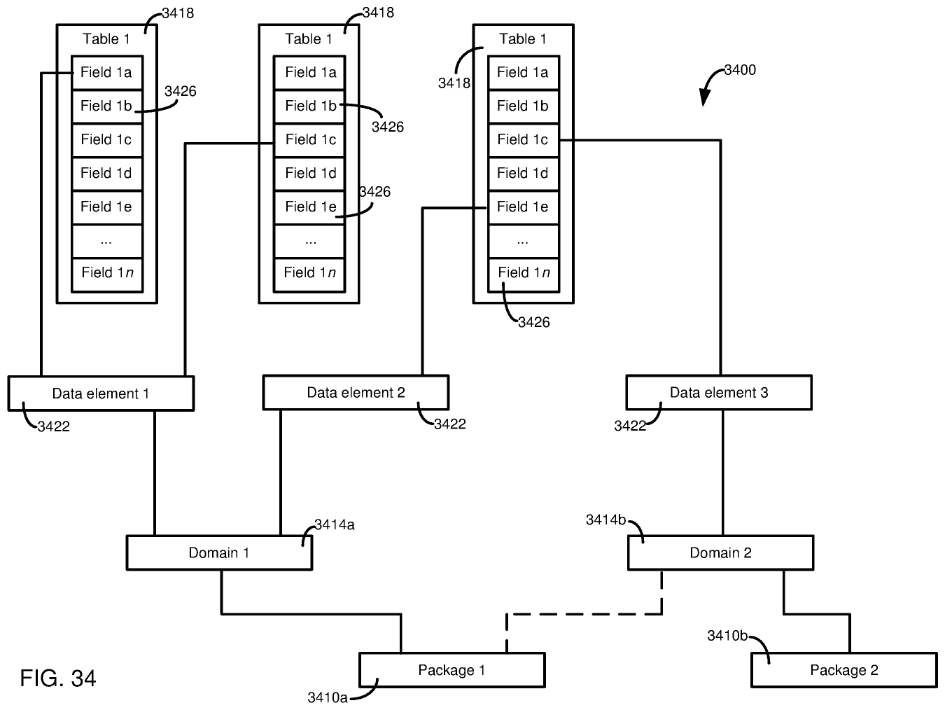

In some cases, data model information can be stored in a data dictionary or similar repository, such as an information schema. An information schema can store information defining an overall data model or schema, tables in the schema, attributes in the tables, and relationships between tables and attributes thereof. However, data model information can include additional types of information, as shown in FIG. 34.

FIG. 34 is a diagram illustrating elements of a database schema 3400 and how they can be interrelated. In at least some cases, the database schema 3400 can be maintained other than at the database layer of a database system. That is, for example, the database schema 3400 can be independent of the underlying database, including a schema used for the underlying database. Typically, the database schema 3400 is mapped to a schema of the database layer, such that records, or portions thereof (e.g., particular values of particular fields) can be retrieved through the database schema 3400.

The database schema 3400 can include one or more packages 3410. A package 3410 can represent an organizational component used to categorize or classify other elements of the schema 3400. For example, the package 3410 can be replicated or deployed to various database systems. The package 3410 can also be used to enforce security restrictions, such as by restricting access of particular users or particular applications to particular schema elements.

A package 3410 can be associated with one or more domains 3414 (i.e., a particular type of semantic identifier or semantic information). In turn, a domain 3414 can be associated with one or more packages 3410. For instance, domain 1, 3414a, is associated only with package 3410a, while domain 2, 3414b, is associated with package 3410a and package 3410b. In at least some cases, a domain 3414 can specify which packages 3410 may use the domain. For instance, it may be that a domain 3414 associated with materials used in a manufacturing process can be used by a process-control application, but not by a human resources application.

In at least some implementations, although multiple packages 3410 can access a domain 3414 (and database objects that incorporate the domain), a domain (and optionally other database objects, such as tables 3418, data elements 3422, and fields 3426, described in more detail below) is primarily assigned to one package. Assigning a domain 3414, and other database objects, to a unique package can help create logical (or semantic) relationships between database objects. In FIG. 34, an assignment of a domain 3414 to a package 3410 is shown as a solid line, while an access permission is shown as a dashed line. So, domain 3414a is assigned to package 3410a, and domain 3414b is assigned to package 3410b. Package 3410a can access domain 3414b, but package 3410b cannot access domain 3414a.

Note that at least certain database objects, such as tables 3418, can include database objects that are associated with multiple packages. For example, a table 3418, Table 1, may be assigned to package A, and have fields that are assigned to package A, package B, and package C. The use of fields assigned to packages A, B, and C in Table 1 creates a semantic relationship between package A and packages B and C, which semantic relationship can be further explained if the fields are associated with particular domains 3414 (that is, the domains can provide further semantic context for database objects that are associated with an object of another package, rather than being assigned to a common package).

As will be explained in more detail, a domain 3414 can represent the most granular unit from which database tables 3418 or other schema elements or objects can be constructed. For instance, a domain 3414 may at least be associated with a datatype. Each domain 3414 is associated with a unique name or identifier, and is typically associated with a description, such as a human readable textual description (or an identifier than can be correlated with a human readable textual description) providing the semantic meaning of the domain. For instance, one domain 3414 can be an integer value representing a phone number, while another domain can be an integer value representing a part number, while yet another integer domain may represent a social security number. The domain 3414 thus can held provide common and consistent use (e.g., semantic meaning) across the schema 3400. That is, for example, whenever a domain representing a social security number is used, the corresponding fields can be recognized as having this meaning even if the fields or data elements have different identifiers or other characteristics for different tables.

The schema 3400 can include one or more data elements 3422. Each data element 3422 is typically associated with a single domain 3414. However, multiple data elements 3422 can be associated with a particular domain 3414. Although not shown, multiple elements of a table 3418 can be associated with the same data element 3422, or can be associated with different data elements having the same domain 3414. Data elements 3422 can serve, among other things, to allow a domain 3414 to be customized for a particular table 3418. Thus, the data elements 3422 can provide additional semantic information for an element of a table 3418.

Tables 3418 include one or more fields 3426, at least a portion of which are mapped to data elements 3422. The fields 3426 can be mapped to a schema of a database layer, or the tables 3418 can be mapped to a database layer in another manner. In any case, in some embodiments, the fields 3426 are mapped to a database layer in some manner Or, a database schema can include semantic information equivalent to elements of the schema 3400, including the domains 3414.

In some embodiments, one or more of the fields 3426 are not mapped to a domain 3414. For example, the fields 3426 can be associated with primitive data components (e.g., primitive datatypes, such as integers, strings, Boolean values, character arrays, etc.), where the primitive data components do not include semantic information. Or, a database system can include one or more tables 3418 that do not include any fields 3426 that are associated with a domain 3414. However, the disclosed technologies include a schema 3400 (which can be separate from, or incorporated into, a database schema) that includes a plurality of tables 3418 having at least one field 3426 that is associated with a domain 3414, directly or through a data element 3422.

### Example 27—Example Data Dictionary

Schema information, such as information associated with the schema 3400 of FIG. 34, can be stored in a repository, such as a data dictionary. As discussed, in at least some cases the data dictionary is independent of, but mapped to, an underlying relational database. Such independence can allow the same database schema 3400 to be mapped to different underlying databases (e.g., databases using software from different vendors, or different software versions or products from the same vendor). The data dictionary can be persisted, such as being maintained in a stored tables, and can be maintained in memory, either in whole or part. An in-memory version of a data dictionary can be referred to as a dictionary buffer.

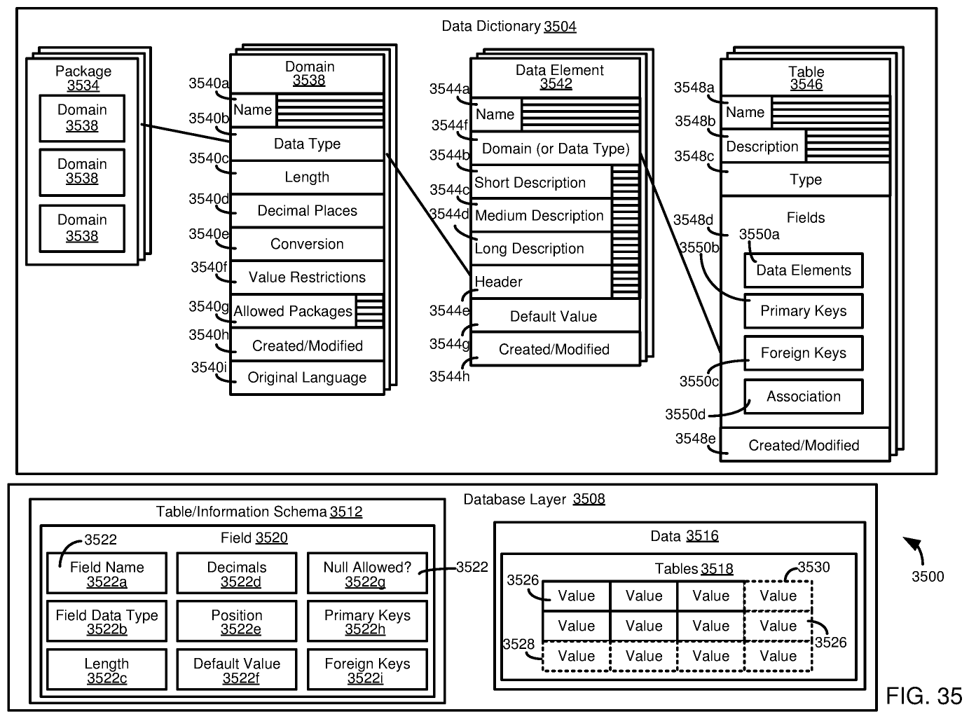

FIG. 35 illustrates a database environment 3500 having a data dictionary 3504 that can access, such as through a mapping, a database layer 3508. The database layer 3508 can include a schema 3512 (e.g., an INFORMATION_SCHEMA as in PostgreSQL) and data 3516, such as data associated with tables 3518. The schema 3512 includes various technical data items/components 3522, which can be associated with a field 3520, such as a field name 3522a (which may or may not correspond to a readily human-understandable description of the purpose of the field, or otherwise explicitly describe the semantic meaning of values for that field), a field data type 3522b (e.g., integer, varchar, string, Boolean), a length 3522c (e.g., the size of a number, the length of a string, etc., allowed for values in the field), a number of decimal places 3522d (optionally, for suitable datatypes, such as, for a float with length 6, specifying whether the values represent XX.XXXX or XXX.XXX), a position 3522e (e.g., a position in the table where the field should be displayed, such as being the first displayed field, the second displayed field, etc.), optionally, a default value 3522f (e.g., “NULL,” “0,” or some other value), a NULL flag 3522g indicating whether NULL values are allowed for the field, a primary key flag 3522h indicating whether the field is, or is used in, a primary key for the table, and a foreign key element 3522i, which can indicate whether the field 3520 is associated with a primary key of another table, and, optionally, an identifier of the table/field referenced by the foreign key element. A particular schema 3512 can include more, fewer, or different technical data items 3522 than shown in FIG. 35.

The tables 3518 are associated with one or more values 3526. The values 3526 are typically associated with a field 3520 defined using one or more of the technical data elements 3522. That is, each row 3528 typically represents a unique tuple or record, and each column 3530 is typically associated with a definition of a particular field 3520. A table 3518 typically is defined as a collection of the fields 3520, and is given a unique identifier.

The data dictionary 3504 includes one or more packages 3534, one or more domains 3538, one or more data elements 3542, and one or more tables 3546, which can at least generally correspond to the similarly titled components 3410, 3414, 3422, 3418, respectively, of FIG. 34. As explained in the discussion of FIG. 34, a package 3534 includes one or more (typically a plurality) of domains 3538. Each domain 3538 is defined by a plurality of domain elements 3540. The domain elements 3540 can include one or more names 3540a. The names 3540a serve to identify, in some cases uniquely, a particular domain 3538. A domain 3538 includes at least one unique name 3540a, and may include one or more names that may or may not be unique. Names which may or may not be unique can include versions of a name, or a description, of the domain 3538 at various lengths or levels of detail. For instance, names 3540a can include text that can be used as a label for the domain 3538, and can include short, medium, and long versions, as well as text that can be specified as a heading. Or, the names 3540a can include a primary name or identifier and a short description or field label that provides human understandable semantics for the domain 3538.

In at least some cases, the data dictionary 3504 can store at least a portion of the names 3540a in multiple languages, such as having domain labels available for multiple languages. In embodiments of the disclosed technologies, when domain information is used for identifying relationships between tables or other database elements or objects, including searching for particular values, information, such as names 3540a, in multiple languages can be searched. For instance, if “customer” is specified, the German and French portion of the names 3540a can be searched as well as an English version.

The domain elements 3540 can also include information that is at least similar to information that can be included in the schema 3512. For example, the domain elements 3540 can include a data type 3540b, a length 3540c, and a number of decimal places 3540d associated with relevant data types, which can correspond to the technical data elements 3522b, 3522c, 3522d, respectively. The domain elements 3540 can include conversion information 3540e. The conversion information 3540e can be used to convert (or interconvert) values entered for the domain 3538 (including, optionally, as modified by a data element 3542). For instance, conversion information 3540 can specify that a number having the form XXXXXXXXX should be converted to XXX-XX-XXXX, or that a number should have decimals or comma separating various groups of numbers (e.g., formatting 1234567 as 1,234,567.00). In some cases, field conversion information for multiple domains 3538 can be stored in a repository, such as a field catalog.

The domain elements 3540 can include one or more value restrictions 3540f. A value restriction 3540f can specify, for example, that negative values are or are not allowed, or particular ranges or threshold of values that are acceptable for a domain 3538. In some cases, an error message or similar indication can be provided as a value is attempted to be used with a domain 3538 that does not comply with a value restriction 3540f. A domain element 3540g can specify one or more packages 3534 that are allowed to use the domain 3538.

A domain element 3540h can specify metadata that records creation or modification events associated with a domain element 3538. For instance, the domain element 3540h can record the identity of a user or application that last modified the domain element 3540h, and a time that the modification occurred. In some cases, the domain element 3540h stores a larger history, including a complete history, of creation and modification of a domain 3538.

A domain element 3540i can specify an original language associated with a domain 3538, including the names 3540a. The domain element 3540i can be useful, for example, when it is to be determined whether the names 3540a should be converted to another language, or how such conversion should be accomplished.

Data elements 3542 can include data element fields 3544, at least some of which can be at least generally similar to domain elements 3540. For example, a data element field 3544a can correspond to at least a portion of the name domain element 3540a, such as being (or including) a unique identifier of a particular data element 3542. The field label information described with respect to the name domain element 3540a is shown as separated into a short description label 3544b, a medium description label 3544c, a long description label 3544d, and a header description 3544e. As described for the name domain element 3540a, the labels and header 3544b-3544e can be maintained in one language or in multiple languages.

A data element field 3544f can specify a domain 3538 that is used with the data element 3542, thus incorporating the features of the domain elements 3540 into the data element. Data element field 3544g can represent a default value for the data element 3542, and can be at least analogous to the default value 3522f of the schema 3512. A created/modified data element field 3544h can be at least generally similar to the domain element 3540h.

Tables 3546 can include one or more table elements 3548. At least a portion of the table elements 3548 can be at least similar to domain elements 3540, such as table element 3548a being at least generally similar to domain element 3540a, or data element field 3544a. A description table element 3548b can be analogous to the description and header labels described in conjunction with the domain element 3540a, or the labels and header data element fields 3544b-3544e. A table 3546 can be associated with a type using table element 3548c. Example table types include transparent tables, cluster tables, and pooled tables, such as used as in database products available from SAP SE of Walldorf, Germany.

Tables 3546 can include one or more field table elements 3548d. A field table element 3548d can define a particular field of a particular database table. Each field table element 3548d can include an identifier 3550a of a particular data element 3542 used for the field. Identifiers 3550b-3550d, can specify whether the field is, or is part of, a primary key for the table (identifier 3550b), or has a relationship with one or more fields of another database table, such as being a foreign key (identifier 3550c) or an association (identifier 3550d).

A created/modified table element 3548e can be at least generally similar to the domain element 3540h.

### Example 28—Computing Systems

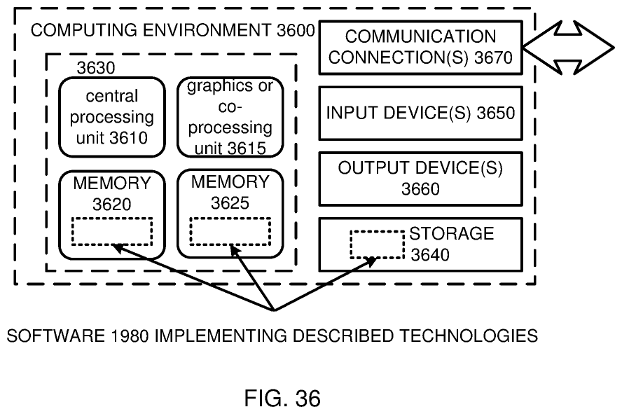

FIG. 36 depicts a generalized example of a suitable computing system 3600 in which the described innovations may be implemented. The computing system 3600 is not intended to suggest any limitation as to scope of use or functionality of the present disclosure, as the innovations may be implemented in diverse general-purpose or special-purpose computing systems.

With reference to FIG. 36, the computing system 3600 includes one or more processing units 3610, 3615 and memory 3620, 3625. In FIG. 36, this basic configuration 3630 is included within a dashed line. The processing units 3610, 3615 execute computer-executable instructions, such as for implementing technologies described in any of Examples 1-27. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 36 shows a central processing unit 3610 as well as a graphics processing unit or co-processing unit 3615. The tangible memory 3620, 3625 may be volatile memory (e.g., registers, cache, RAM), non-volatile memory (e.g., ROM, EEPROM, flash memory, etc.), or some combination of the two, accessible by the processing unit(s) 3610, 3615. The memory 3620, 3625 stores software 3680 implementing one or more innovations described herein, in the form of computer-executable instructions suitable for execution by the processing unit(s) 3610, 3615.

A computing system 3600 may have additional features. For example, the computing system 3600 includes storage 3640, one or more input devices 3650, one or more output devices 3660, and one or more communication connections 3670. An interconnection mechanism (not shown) such as a bus, controller, or network interconnects the components of the computing system 3600. Typically, operating system software (not shown) provides an operating environment for other software executing in the computing system 3600, and coordinates activities of the components of the computing system 3600.

The tangible storage 3640 may be removable or non-removable, and includes magnetic disks, magnetic tapes or cassettes, CD-ROMs, DVDs, or any other medium which can be used to store information in a non-transitory way and which can be accessed within the computing system 3600. The storage 3640 stores instructions for the software 3680 implementing one or more innovations described herein.

The input device(s) 3650 may be a touch input device such as a keyboard, mouse, pen, or trackball, a voice input device, a scanning device, or another device that provides input to the computing system 3600. The output device(s) 3660 may be a display, printer, speaker, CD-writer, or another device that provides output from the computing system 3600.

The communication connection(s) 3670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 29—Cloud Computing Environment

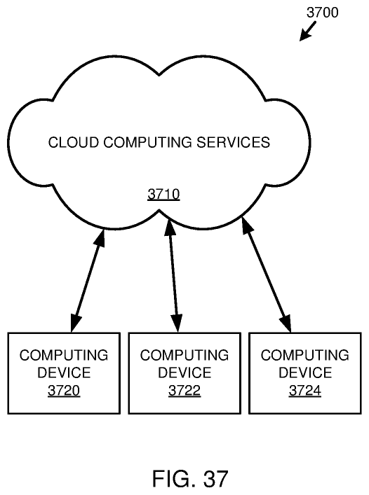

FIG. 37 depicts an example cloud computing environment 3700 in which the described technologies can be implemented, such as a cloud system 2514 of FIG. 25. The cloud computing environment 3700 comprises cloud computing services 3710. The cloud computing services 3710 can comprise various types of cloud computing resources, such as computer servers, data storage repositories, networking resources, etc. The cloud computing services 3710 can be centrally located (e.g., provided by a data center of a business or organization) or distributed (e.g., provided by various computing resources located at different locations, such as different data centers and/or located in different cities or countries).

The cloud computing services 3710 are utilized by various types of computing devices (e.g., client computing devices), such as computing devices 3720, 3722, and 3724. For example, the computing devices (e.g., 3720, 3722, and 3724) can be computers (e.g., desktop or laptop computers), mobile devices (e.g., tablet computers or smart phones), or other types of computing devices. For example, the computing devices (e.g., 3720, 3722, and 3724) can utilize the cloud computing services 3710 to perform computing operators (e.g., data processing, data storage, and the like). The computing devices 3720, 3722, 3724 can correspond to the local system 2510 FIG. 25, or can represent a client device, such as a client 2516, 2518.

### Example 30—Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 36, computer-readable storage media include memory 3620 and 3625, and storage 3640. The term computer-readable storage media does not include signals and carrier waves. In addition, the term computer-readable storage media does not include communication connections (e.g., 3670).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. It should be understood that the disclosed technology is not limited to any specific computer language or program. For instance, the disclosed technology can be implemented by software written in C, C++, C#, Java, Perl, JavaScript, Python, Ruby, ABAP, SQL, XCode, GO, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims

What is claimed is:

1. A computing system comprising:
memory;
one or more processing units coupled to the memory; and
one or more computer readable storage media storing instructions that, when loaded into the memory, cause the one or more processing units to perform operations for:
receiving a request for a putative value for a first user interface control of a graphical user interface;
determining a method specified for the user interface control, the method being a member function of a logical data object comprising a plurality of variables, wherein the user interface control is programmed to specify a first value for at least a first variable of the plurality of variables;
retrieving a second value for at least a second variable of the plurality of variables;
providing the second value to a trained machine learning model specified for the method;
generating at least one result value for the first value using the trained machine learning model; and
displaying the at least one result value on the graphical user interface as the putative value.

2. The computing system of claim 1, the operations further comprising:
training the machine learning model using values for a plurality of instances of the logical data object.

3. The computing system of claim 2, the operations further comprising:
defining a training data view, the training data view specifying variables of the plurality of instances of the logical data object to be used in the training the machine learning model.

4. The computing system of claim 1, the operations further comprising:
receiving user input accepting or rejecting the at least one result value.

5. The computing system of claim 1, the operations further comprising:
displaying on the graphical user interface one or more confidence measures for the at least one result value.

6. The computing system of claim 5, wherein one or more confidence measures comprise an accuracy of the at least one result value.

7. The computing system of claim 1, wherein generating at least one result value comprises generating a plurality of result values and displaying the at least one result value on the graphical user interface comprises displaying multiple result values of the plurality of result values.

8. The computing system of claim 7, the operations further comprising:
ranking the multiple result values; wherein displaying the at least one result value on the graphical user interface comprises displaying the multiple result values according to the ranking.

9. The computing system of claim 1, the operations further comprising:
receiving user input for a second user interface control of the graphical user interface, wherein the user input comprises the second value.

10. The computing system of claim 1, the operations further comprising:
storing a definition of an input value retrieval scenario, the input value retrieval scenario specifying:
an identifier of a machine learning algorithm for the trained machine learning model; and
data to be retrieved from a plurality of instances of the logical data model.

11. The computing system of claim 1 wherein, the graphical user interface comprises a plurality of user interface controls, the plurality of user interface controls comprising the first user interface control, further comprising:
generating a data artefact associating multiple user interface controls of the plurality of user interface controls with respective methods for obtaining a putative value for a given user interface control of the plurality of user interface controls.

12. A method, implemented in a computing system comprising a memory and one or more processors, comprising:
training a machine learning model with values for a plurality of data members of at least a first type of logical data object to provide a trained machine learning model;
defining a first interface to the trained machine learning model for a first value generation method of the first type of logical data object; and
defining the first value generation method for the first type of logical data object, the first value generation method specifying the first interface.

13. The method of claim 12, wherein the values for the plurality of data members are specified by a view that references the first type of logical data object.

14. The method of claim 12, further comprising:
registering the first value generation method with a first user interface control of a display provided by a graphical user interface.

15. The method of claim 12, further comprising:
registering an explanation method for the first user interface control or the first value generation method, the explanation method configured to calculate and display selection criteria for one or more putative values provided by the first value generation method.

16. The method of claim 12, further comprising:
receiving one or more values for respective data members of the logical data object; and
receiving a request to execute the first value generation method, the request comprising the one or more values.

17. One or more computer-readable storage media storing:
computer-executable instructions that, when executed, cause a computing device to define a first interface for a trained machine learning model for a first value generation method of a first type of data object, the trained machine learning model having been generating by processing data for a plurality of instances of the first type of data object with a machine learning algorithm;
computer-executable instructions that, when executed, cause a computing device to define the first value generation method for the first type of data object, the first value generation method specifying the first interface; and
computer-executable instructions that, when executed, cause a computing device to register the first value generation method with a first user interface control of a first display of a graphical user interface.

18. The one or more computer-readable storage media of claim 17, further comprising:
computer-executable instructions that, when executed, cause a computing device to register an explanation method for the first user interface control or the first value generation method, the explanation method configured to calculate and display selection criteria for one or more putative values provided by the first value generation method.

19. The one or more computer-readable storage media of claim 17, further comprising:
computer-executable instructions that, when executed, cause a computing device to receive one or more values for respective data members of the logical data object; and
computer-executable instructions that, when executed, cause a computing device to receive a request to execute the first value generation method, the request comprising the one or more values.

20. The one or more computer-readable storage media of claim 19, further comprising:
computer-executable instructions that, when executed, cause a computing device to execute the first value generation method, wherein execution of the first value generation method comprises:
calling the first interface, wherein a call to the first interface comprises at least one of the one or more values;
receiving one or more execution results from the trained machine learning model; and
returning at least one of the one or more execution results in response to the request to execute the first value generation method.
